(19) United States
(12) Patent Application Publication
(10) Pub. No.: US 2017/0026824 A1
(43) Pub. Date: Jan. 26, 2017

(54) METHOD FOR COMMUNICATING ROUTING RULES

(71) Applicant: LG ELECTRONICS INC., Seoul (KR)

(72) Inventors: Laeyoung Kim, Seoul (KR); Jinsook Ryu, Seoul (KR); Hyunsock Kim, Seoul (KR); Jaehyun Kim, Seoul (KR)

(73) Assignee: LG Electronics Inc., Seoul (KR)

(21) Appl. No.: 15/302,417

(22) PCT Filed: Apr. 17, 2015
(86) PCT No.: PCT/KR2015/003872

§ 371 Date: Oct. 6, 2016

Related U.S. Application Data
(60) Provisional application No. 61/992,194, filed on May 12, 2014.
(60) Provisional application No. 61/991,598, filed on May 11, 2014.
(60) Provisional application No. 61/980,587, filed on Apr. 17, 2014.

(51) Int. Cl. H04W 8/08; H04W 64/00; H04W 76/02; H04W 40/24; H04W 72/04

(52) U.S. Cl. CPC H04W 8/08; H04W 40/24; H04W 72/0493; H04W 76/021; H04W 64/00; H04W 88/16

(57) ABSTRACT

One disclosure of the present specification provides a method whereby a network entity in charge of a control plane communicates routing rules. The method may comprise the steps of: receiving a network-initiated network-based IP flow mobility (NBIFOM) request from user equipment (UE); receiving a setting for a presence report region from a server; determining whether or not the user equipment (UE) has entered a predetermined location on the basis of the setting for the presence report region; communicating information on the presence report region if the user equipment (UE) has entered the predetermined location; receiving routing rules from the server; and communicating the routing rules to the user equipment (UE).

### CROSS-REFERENCE TO RELATED APPLICATIONS

This application claims the benefit of priority of U.S. Provisional application No. 61/980,587 filed on Apr. 17, 2014, No. 61/991,598 filed on May 11, 2014, and No. 61/992,194 filed on May 12, 2014, the contents of which are all hereby incorporated by reference herein in their entirety.

### BACKGROUND OF THE INVENTION

Field of the Invention

The present invention relates to a mobile communication.

Related Art

In 3GPP in which technical standards for mobile communication systems are established, in order to handle 4th generation communication and several related forums and new technologies, research on Long Term Evolution/System Architecture Evolution (LTE/SAE) technology has started as part of efforts to optimize and improve the performance of 3GPP technologies from the end of the year 2004

SAE that has been performed based on 3GPP SA WG2 is research regarding network technology that aims to determine the structure of a network and to support mobility between heterogeneous networks in line with an LTE task of a 3GPP TSG RAN and is one of recent important standardization issues of 3GPP. SAE is a task for developing a 3GPP system into a system that supports various radio access technologies based on an IP, and the task has been carried out for the purpose of an optimized packet-based system which minimizes transmission delay with a more improved data transmission capability.

An Evolved Packet System (EPS) higher level reference model defined in 3GPP SA WG2 includes a non-roaming case and roaming cases having various scenarios, and for details therefor, reference can be made to 3GPP standard documents TS 23.401 and TS 23.402. A network configuration of FIG. 1 has been briefly reconfigured from the EPS higher level reference model.

FIG. 1 shows the configuration of an evolved mobile communication network.

An Evolved Packet Core (EPC) may include various elements. FIG. 1 illustrates a Serving Gateway (S-GW) 52, a Packet Data Network Gateway (PDN GW) 53, a Mobility Management Entity (MME) 51, a Serving General Packet Radio Service (GPRS) Supporting Node (SGSN), and an enhanced Packet Data Gateway (ePDG) that correspond to some of the various elements.

The S-GW 52 is an element that operates at a boundary point between a Radio Access Network (RAN) and a core network and has a function of maintaining a data path between an eNodeB 22 and the PDN GW 53. Furthermore, if a terminal (or User Equipment (UE) moves in a region in which service is provided by the eNodeB 22, the S-GW 52 plays a role of a local mobility anchor point. That is, for mobility within an E-UTRAN (i.e., a Universal Mobile Telecommunications System (Evolved-UMTS) Terrestrial Radio Access Network defined after 3GPP release-8), packets can be routed through the S-GW 52. Furthermore, the S-GW 52 may play a role of an anchor point for mobility with another 3GPP network (i.e., a RAN defined prior to 3GPP release-8, for example, a UTRAN or Global System for Mobile communication (GSM) (GERAN)/Enhanced Data rates for Global Evolution (EDGE) Radio Access Network).

The PDN GW (or P-GW) 53 corresponds to the termination point of a data interface toward a packet data network. The PDN GW 53 can support policy enforcement features, packet filtering, charging support, etc. Furthermore, the PDN GW (or P-GW) 53 can play a role of an anchor point for mobility management with a 3GPP network and a non-3GPP network (e.g., an unreliable network, such as an Interworking Wireless Local Area Network (I-WLAN), a Code Division Multiple Access (CDMA) network, or a reliable network, such as WiMax).

In the network configuration of FIG. 1, the S-GW 52 and the PDN GW 53 have been illustrated as being separate gateways, but the two gateways may be implemented in accordance with a single gateway configuration option.

The MME 51 is an element for performing the access of a terminal to a network connection and signaling and control functions for supporting the allocation, tracking, paging, roaming, handover, etc. of network resources. The MME 51 controls control plane functions related to subscribers and session management. The MME 51 manages numerous eNodeBs 22 and performs conventional signaling for selecting a gateway for handover to another 2G/3G networks. Furthermore, the MME 51 performs functions, such as security procedures, terminal-to-network session handling, and idle terminal location management.

The SGSN handles all packet data, such as a user's mobility management and authentication for different access 3GPP networks (e.g., a GPRS network and an UTRAN/GERAN).

The ePDG plays a role of a security node for an unreliable non-3GPP network (e.g., an I-WLAN and a Wi-Fi hotspot).

As described with reference to FIG. 1, a terminal (or UE) having an IP capability can access an IP service network (e.g., IMS), provided by a service provider (i.e., an operator), via various elements within an EPC based on non-3GPP access as well as based on 3GPP access.

Furthermore, FIG. 1 shows various reference points (e.g., S1-U and S1-MME). In a 3GPP system, a conceptual link that connects two functions that are present in the different function entities of an E-UTRAN and an EPC is called a reference point. Table 1 below defines reference points shown in FIG. 1. In addition to the reference points shown in the example of Table 1, various reference points may be present depending on a network configuration.

TABLE 1

| REFERENCE | |
|---|---|
| POINT | DESCRIPTION |
| S1-MME | A reference point for a control plane protocol between the |
| | E-UTRAN and the MME |
| S1-U | A reference point between the E-UTRAN and the S-GW |
| | for path switching between eNodeBs during handover and |
| | user plane tunneling per bearer |
| S3 | A reference point between the MME and the SGSN that |
| | provides the exchange of pieces of user and bearer |
| | information for mobility between 3GPP access networks |
| | in idle and/or activation state. This reference point can be |
| | used intra-PLMN or inter-PLMN (e.g. in the case of |
| | Inter-PLMN HO). |
| S4 | A reference point between the SGW and the SGSN that |
| | provides related control and mobility support between the |
| | 3GPP anchor functions of a GPRS core and the S-GW. |
| | Furthermore, if a direct tunnel is not established, the |
| | reference point provides user plane tunneling. |
| S5 | A reference point that provides user plane tunneling and |
| | tunnel management between the S-GW and the PDN GW. |
| | The reference point is used for S-GW relocation due to |
| | UE mobility and if the S-GW needs to connect to a non- |
| | collocated PDN GW for required PDN connectivity |
| S11 | A reference point between the MME and the S-GW |
| SGi | A reference point between the PDN GW and the PDN. |
| | The PDN may be a public or private PDN external to an |
| | operator or may be an intra-operator PDN, e.g., for the |
| | providing of IMS services. This reference point |
| | corresponds to Gi for 3GPP access. |

FIG. 2 is an exemplary diagram showing the architecture of a common E-UTRAN and a common EPC.

As shown in FIG. 2, the eNodeB 20 can perform functions, such as routing to a gateway while RRC connection is activated, the scheduling and transmission of a paging message, the scheduling and transmission of a broadcast channel (BCH), the dynamic allocation of resources to UE in uplink and downlink, a configuration and providing for the measurement of the eNodeB 20, control of a radio bearer, radio admission control, and connection mobility control. The EPC can perform functions, such as the generation of paging, the management of an LTE_IDLE state, the ciphering of a user plane, control of an EPS bearer, the ciphering of NAS signaling, and integrity protection.

FIG. 3 is an exemplary diagram showing the structure of a radio interface protocol in a control plane between UE and an eNodeB, and FIG. 4 is another exemplary diagram showing the structure of a radio interface protocol in a control plane between UE and an eNodeB.

The radio interface protocol is based on a 3GPP radio access network standard. The radio interface protocol includes a physical layer, a data link layer, and a network layer horizontally, and it is divided into a user plane for the transmission of information and a control plane for the transfer of a control signal (or signaling).

The protocol layers may be classified into a first layer (L1), a second layer (L2), and a third layer (L3) based on three lower layers of the Open System Interconnection (OSI) reference model that is widely known in communication systems.

The layers of the radio protocol of the control plane shown in FIG. 3 and the radio protocol in the user plane of FIG. 4 are described below.

The physical layer PHY, that is, the first layer, provides information transfer service using physical channels. The PHY layer is connected to a Medium Access Control (MAC) layer placed in a higher layer through a transport channel, and data is transferred between the MAC layer and the PHY layer through the transport channel. Furthermore, data is transferred between different PHY layers, that is, PHY layers on the sender side and the receiver side, through the PHY layer.

A physical channel is made up of multiple subframes on a time axis and multiple subcarriers on a frequency axis. Here, one subframe is made up of a plurality of symbols and a plurality of subcarriers on the time axis. One subframe is made up of a plurality of resource blocks, and one resource block is made up of a plurality of symbols and a plurality of subcarriers. A Transmission Time Interval (TTI), that is, a unit time during which data is transmitted, is 1 ms corresponding to one subframe.

In accordance with 3GPP LTE, physical channels that are present in the physical layer of the sender side and the receiver side can be divided into a Physical Downlink Shared Channel (PDSCH) and a Physical Uplink Shared Channel (PUSCH), that is, data channels, and a Physical Downlink Control Channel (PDCCH), a Physical Control Format Indicator Channel (PCFICH), a Physical Hybrid-ARQ Indicator Channel (PHICH), and a Physical Uplink Control Channel (PUCCH), that is, control channels.

A PCFICH that is transmitted in the first OFDM symbol of a subframe carries a Control Format Indicator (CFI) regarding the number of OFDM symbols (i.e., the size of a control region) used to send control channels within the subframe. A wireless device first receives a CFI on a PCFICH and then monitors PDCCHs.

Unlike a PDCCH, a PCFICH is transmitted through the fixed PCFICH resources of a subframe without using blind decoding.

A PHICH carries positive-acknowledgement (ACK)/negative-acknowledgement (NACK) signals for an uplink (UL) Hybrid Automatic Repeat reQuest (HARQ). ACK/NACK signals for UL data on a PUSCH that is transmitted by a wireless device are transmitted on a PHICH.

A Physical Broadcast Channel (PBCH) is transmitted in four former OFDM symbols of the second slot of the first subframe of a radio frame. The PBCH carries system information that is essential for a wireless device to communicate with an eNodeB, and system information transmitted through a PBCH is called a Master Information Block (MIB). In contrast, system information transmitted on a PDSCH indicated by a PDCCH is called a System Information Block (SIB).

A PDCCH can carry the resource allocation and transport format of a downlink-shared channel (DL-SCH), information about the resource allocation of an uplink shared channel (UL-SCH), paging information for a PCH, system information for a DL-SCH, the resource allocation of an upper layer control message transmitted on a PDSCH, such as a random access response, a set of transmit power control commands for pieces of UE within a specific UE group, and the activation of a Voice over Internet Protocol (VoIP). A plurality of PDCCHs can be transmitted within the control region, and UE can monitor a plurality of PDCCHs. A PDCCH is transmitted on one Control Channel Element (CCE) or an aggregation of multiple contiguous CCEs. A CCE is a logical allocation unit used to provide a PDCCH with a coding rate according to the state of a radio channel A CCE corresponds to a plurality of resource element groups. The format of a PDCCH and the number of bits of a possible PDCCH are determined by a relationship between the number of CCEs and a coding rate provided by CCEs.

Control information transmitted through a PDCCH is called Downlink Control Information (DCI). DCI can include the resource allocation of a PDSCH (also called a downlink (DL) grant)), the resource allocation of a PUSCH (also called an uplink (UL) grant), a set of transmit power control commands for pieces of UE within a specific UE group, and/or the activation of a Voice over Internet Protocol (VoIP).

Several layers are present in the second layer. First, a Medium Access Control (MAC) layer functions to map various logical channels to various transport channels and also plays a role of logical channel multiplexing for mapping multiple logical channels to one transport channel. The MAC layer is connected to a Radio Link Control (RLC) layer, that is, a higher layer, through a logical channel. The logical channel is basically divided into a control channel through which information of the control plane is transmitted and a traffic channel through which information of the user plane is transmitted depending on the type of transmitted information.

The RLC layer of the second layer functions to control a data size that is suitable for sending, by a lower layer, data received from a higher layer in a radio section by segmenting and concatenating the data. Furthermore, in order to guarantee various types of QoS required by radio bearers, the RLC layer provides three types of operation modes: a Transparent Mode (TM), an Un-acknowledged Mode (UM), and an Acknowledged Mode (AM). In particular, AM RLC performs a retransmission function through an Automatic Repeat and Request (ARQ) function for reliable data transmission.

The Packet Data Convergence Protocol (PDCP) layer of the second layer performs a header compression function for reducing the size of an IP packet header containing control information that is relatively large in size and unnecessary in order to efficiently send an IP packet, such as IPv4 or IPv6, in a radio section having a small bandwidth when sending the IP packet. Accordingly, transmission efficiency of the radio section can be increased because only essential information is transmitted in the header part of data. Furthermore, in an LTE system, the PDCP layer also performs a security function. The security function includes ciphering for preventing the interception of data by a third party and integrity protection for preventing the manipulation of data by a third party.

A Radio Resource Control (RRC) layer at the highest place of the third layer is defined only in the control plane and is responsible for control of logical channels, transport channels, and physical channels in relation to the configuration, re-configuration, and release of Radio Bearers (RBs). Here, the RB means service provided by the second layer in order to transfer data between UE and an E-UTRAN.

If an RRC connection is present between the RRC layer of UE and the RRC layer of a wireless network, the UE is in an RRC_CONNECTED state. If not, the UE is in an RRC_IDLE state.

An RRC state and an RRC connection method of UE are described below. The RRC state means whether or not the RRC layer of UE has been logically connected to the RRC layer of an E-UTRAN. If the RRC layer of UE is logically connected to the RRC layer of an E-UTRAN, it is called the RRC_CONNECTED state. If the RRC layer of UE is not logically connected to the RRC layer of an E-UTRAN, it is called the RRC_IDLE state. Since UE in the RRC_CONNECTED state has an RRC connection, an E-UTRAN can check the existence of the UE in a cell unit, and thus control the UE effectively. In contrast, if UE is in the RRC_IDLE state, an E-UTRAN cannot check the existence of the UE, and a core network is managed in a Tracking Area (TA) unit, that is, an area unit greater than a cell. That is, only the existence of UE in the RRC_IDLE state is checked in an area unit greater than a cell. In such a case, the UE needs to shift to the RRC_CONNECTED state in order to be provided with common mobile communication service, such as voice or data. Each TA is classified through Tracking Area Identity (TAI). UE can configure TAI through Tracking Area Code (TAC), that is, information broadcasted by a cell.

When a user first turns on the power of UE, the UE first searches for a proper cell, establishes an RRC connection in the corresponding cell, and registers information about the UE with a core network. Thereafter, the UE stays in the RRC_IDLE state. The UE in the RRC_IDLE state (re)selects a cell if necessary and checks system information or paging information. This process is called camp on. When the UE in the RRC_IDLE state needs to establish an RRC connection, the UE establishes an RRC connection with the RRC layer of an E-UTRAN through an RRC connection procedure and shifts to the RRC_CONNECTED state. A case where the UE in the RRC_IDLE state needs to establish with an RRC connection includes multiple cases. The multiple cases may include, for example, a case where UL data needs to be transmitted for a reason, such as a call attempt made by a user and a case where a response message needs to be transmitted in response to a paging message received from an E-UTRAN.

A Non-Access Stratum (NAS) layer placed over the RRC layer performs functions, such as session management and mobility management.

The NAS layer shown in FIG. 3 is described in detail below.

Evolved Session Management (ESM) belonging to the NAS layer performs functions, such as the management of default bearers and the management of dedicated bearers, and ESM is responsible for control that is necessary for UE to use PS service from a network. Default bearer resources are characterized in that they are allocated by a network when UE first accesses a specific Packet Data Network (PDN) or accesses a network. Here, the network allocates an IP address available for UE so that the UE can use data service and the QoS of a default bearer. LTE supports two types of bearers: a bearer having Guaranteed Bit Rate (GBR) QoS characteristic that guarantees a specific bandwidth for the transmission and reception of data and a non-GBR bearer having the best effort QoS characteristic without guaranteeing a bandwidth. A default bearer is assigned a non-GBR bearer, and a dedicated bearer may be assigned a bearer having a GBR or non-GBR QoS characteristic.

In a network, a bearer assigned to UE is called an Evolved Packet Service (EPS) bearer. When assigning an EPS bearer, a network assigns one ID. This is called an EPS bearer ID. One EPS bearer has QoS characteristics of a Maximum Bit Rate (MBR) and a Guaranteed Bit Rate (GBR) or an Aggregated Maximum Bit Rate (AMBR).

FIG. 5a is a flowchart illustrating a random access process in 3GPP LTE.

The random access process is used for UE 10 to obtain UL synchronization with a base station, that is, an eNodeB 20, or to be assigned UL radio resources.

The UE 10 receives a root index and a physical random access channel (PRACH) configuration index from the eNodeB 20. 64 candidate random access preambles defined by a Zadoff-Chu (ZC) sequence are present in each cell. The root index is a logical index that is used for the UE to generate the 64 candidate random access preambles.

The transmission of a random access preamble is limited to specific time and frequency resources in each cell. The PRACH configuration index indicates a specific subframe on which a random access preamble can be transmitted and a preamble format.

The UE 10 sends a randomly selected random access preamble to the eNodeB 20. Here, the UE 10 selects one of the 64 candidate random access preambles. Furthermore, the UE selects a subframe corresponding to the PRACH configuration index. The UE 10 sends the selected random access preamble in the selected subframe.

The eNodeB 20 that has received the random access preamble sends a Random Access Response (RAR) to the UE 10. The random access response is detected in two steps. First, the UE 10 detects a PDCCH masked with a random access-RNTI (RA-RNTI). The UE 10 receives a random access response within a Medium Access Control (MAC) Protocol Data Unit (PDU) on a PDSCH that is indicated by the detected PDCCH.

FIG. 5b illustrates a connection process in a radio resource control (RRC) layer.

FIG. 5b shows an RRC state depending on whether there is an RRC connection. The RRC state denotes whether the entity of the RRC layer of UE 10 is in logical connection with the entity of the RRC layer of eNodeB 20, and if yes, it is referred to as RRC connected state, and if no as RRC idle state.

In the connected state, UE 10 has an RRC connection, and thus, the E-UTRAN may grasp the presence of the UE on a cell basis and may thus effectively control UE 10. In contrast, UE 10 in the idle state cannot grasp eNodeB 20 and is managed by a core network on the basis of a tracking area that is larger than a cell. The tracking area is a set of cells. That is, UE 10 in the idle state is grasped for its presence only on a larger area basis, and the UE should switch to the connected state to receive a typical mobile communication service such as voice or data service.

When the user turns on UE 10, UE 10 searches for a proper cell and stays in idle state in the cell. UE 10, when required, establishes an RRC connection with the RRC layer of eNodeB 20 through an RRC connection procedure and transits to the RRC connected state.

There are a number of situations where the UE staying in the idle state needs to establish an RRC connection, for example, when the user attempts to call or when uplink data transmission is needed, or when transmitting a message responsive to reception of a paging message from the EUTRAN.

In order for the idle UE 10 to be RRC connected with eNodeB 20, UE 10 needs to perform the RRC connection procedure as described above. The RRC connection procedure generally comes with the process in which UE 10 transmits an RRC connection request message to eNodeB 20, the process in which eNodeB 20 transmits an RRC connection setup message to UE 10, and the process in which UE 10 transmits an RRC connection setup complete message to eNodeB 20. The processes are described in further detail with reference to FIG. 6.

1) The idle UE 10, when attempting to establish an RRC connection, e.g., for attempting to call or transmit data or responding to paging from eNodeB 20, sends an RRC connection request message to eNodeB 20.

2) When receiving the RRC connection message from UE 10, eNodeB 20 accepts the RRC connection request from UE 10 if there are enough radio resources, and eNodeB 20 sends a response message, RRC connection setup message, to UE 10.

3) When receiving the RRC connection setup message, UE 10 transmits an RRC connection setup complete message to eNodeB 20. If UE 10 successfully transmits the RRC connection setup message, UE 10 happens to establish an RRC connection with eNodeB 20 and switches to the RRC connected state.

Meanwhile, with an explosive increase in data in recent years, a 3GPP access of a mobile communication operator is becoming more congested. As a way of solving this problem, there is an attempt to offload data of a user equipment (UE) through a WLAN which is a non-3GPP access. Hereinafter, an architecture for connecting the WLAN to an EPC is described.

FIG. 6a and FIG. 6b illustrate an architecture for connecting a WLAN to an EPC.

FIG. 6a illustrates an architecture in which a WLAN is connected to a P-GW through an S2a interface. As can be seen with reference to FIG. 6a, a WLAN access network (in particular, it is a trusted WLAN access network since the S2a interface is an interface for connecting a trusted non-3GPP access to the EPC) is connected to the P-GW through the S2a interface. The content disclosed in TS 23.402 is incorporated herein by reference for an architecture for a trusted WLAN access network (TWAN).

FIG. 6b illustrates an architecture in which a WLAN is connected to a P-GW through an S2b interface. As can be seen with reference to FIG. 6b, a WLAN access network (in particular, it is an untrusted WLAN access network since the S2b interface is an interface for connecting an untrusted non-3GPP access to the EPC) is connected to the P-GW through an evolved packet data gateway (ePDG) connected to the P-GW through the S2b interface.

Hereinafter, a trusted WLAN and an untrusted WLAN may be both referred to as a WLAN.

Meanwhile, with a trend for offloading data of a UE not through a 3GPP access of an operator but through a WLAN which is a non-3GPP access, a technology such as IP flow mobility and seamless offload (IFOM), multi access PDN connectivity (MAPCON), or the like has been proposed to support a multiple radio access. The MAPCON technology is a technology of transmitting data by using a 3GPP access and a Wi-Fi access through respective PDN connections. The IFOM technology is a technology of transmitting data by aggregating the 3GPP access and the Wi-Fi access to one PDN or P-GW.

FIG. 7a is an exemplary diagram of the IFOM technology.

Referring to FIG. 7a, the IFOM technology is to provide the same PDN connection through several pieces of different access. Such IFOM technology provides seamless offloading onto a WLAN.

Furthermore, the IFOM technology provides the transfer of IP flows having the same one PDN connection from one access to the other access.

FIG. 7b is an exemplary diagram of the MAPCON technology.

As can be seen with reference to FIG. 7b, the MAPCON technology is to connect several PDN connections, easily, IP flows to other APNs through another access system.

In accordance with such MAPCON technology, the UE 10 can generate a new PDN connection on access that has not been used before. Alternatively, the UE 10 can generate a new PDN connection in one of several pieces of access that were used before. Alternatively, the UE 10 may transfer some of or all PDN connections to another access.

As described above, with the help of the technologies capable of offloading the traffic of UE onto a WLAN, the congestion of the core network of a mobile communication service provider can be reduced.

The provider provides a policy to the UE in order to divert the traffic onto a general data communication network and the UE may divert data thereof onto the wireless LAN according to the policy.

In order to provision the policy the UE, a 3GPP based access network discovery and selection function (ANDSF) is enhanced to provide a policy associated with the wireless LAN.

FIGS. 8a and 8b show network control entities for selecting an access network.

As can be seen with reference to FIG. 8a, the ANDSF may be present in the home network (Home Public Land Mobile Network (hereinafter called ‘HPLMN’)) of the UE 10. Furthermore, as can be seen with reference to FIG. 8b, the ANDSF may also be present in the Visited Public Land Mobile Network (hereinafter called ‘VPLMN’) of the UE 10. When the ANDSF is present in a home network as described above, it may be called an H-ANDSF 61. When the ANDSF is present in a visited network, it may be called a V-ANDSF 62. Hereinafter, the ANDSF 60 generally refers to the H-ANDSF 61 or the V-ANDSF 62.

The ANDSF can provide information about an inter-system movement policy, information for access network search, and information about inter-system routing, for example, a routing rule.

As described above, the IFOM is performed based on a decision primarily made by the UE, and uses a dual stack mobile IP (DSMIP) which is a host-based mobility protocol.

Meanwhile, a technology for providing the IFOM through the S2a and S2b interfaces using GTP or PMIP which is a network-based protocol is called a network based IP flow mobility (NBIFOM).

However, problematically, this cannot be implemented since the NBIFOM is only in a discussion phase at present and thus there is no specific technology proposed.

In addition, information indicating a current location of the UE is necessary in order for a network to properly offload traffic of the UE to the WLAN. However, problematically, there is no specific technology proposed for this issue at present.

### SUMMARY OF THE INVENTION

Accordingly, an object of the present invention is to present a method that can solve the aforementioned problem.

In order to achieve the above object, one disclosure of the present specification provides a method of delivering a routing rule in a network entity in charge of a control plane. The method may include: receiving a network-initiated network-based IP flow mobility (NBIFOM) request from a user equipment (UE); receiving a configuration of a presence reporting area from a server; determining whether the UE has entered a specific location on the basis of the configuration of the presence reporting area; delivering information on the presence reporting area if the UE has entered the specific location; receiving a routing rule from the server; and delivering the routing rule to the UE.

The specific location may be confirmed through a cell identifier (ID) included in an S1-AP message in which a message of a non access stratum (NAS) layer from the UE is encapsulated. Herein, the message of the NAS layer may correspond to any one of a tracking area update (TAU) request message and a service request message.

The network-initiated NBIFOM request from the UE may be received by being included in a packet data network (PDN) connectivity request message or an attach request message. The configuration of the presence reporting area may be received by being included in a create session response message.

The receiving of the configuration of the presence reporting area may include: receiving by a packet data network gateway (PDN-GW) the configuration of the present reporting area from the server; receiving by a serving gateway (S-GW) the configuration of the presence reporting area from the PDN-GW; and receiving by the network entity the configuration of the presence reporting area from the S-GW.

The network entity may be a mobility management entity (MME), and the server may be a policy and charging rule function (PCRF).

Meanwhile, in order to achieve the above object, one disclosure of the present specification provides a network entity in charge of a control plane. The network entity may include: a transceiver for receiving a network-initiated NBIFOM request from a UE, and for receiving a configuration of a presence reporting area from a server; and a controller for determining whether the UE has entered a specific location on the basis of the configuration of the presence reporting area. Herein, if the UE has entered the specific location, the controller may deliver information on the presence reporting area via the transceiver, and thereafter upon receiving a routing rule from the server, deliver the routing rule to the UE.

According to the embodiments of the present invention, the problems in the related art can be solved.

### BRIEF DESCRIPTION OF THE DRAWINGS

FIG. 1 is a structural diagram of an evolved mobile communication network.

FIG. 2 is an exemplary diagram illustrating architectures of a general E-UTRAN and a general EPC.

FIG. 3 is an exemplary diagram illustrating a structure of a radio interface protocol on a control plane between UE and eNodeB.

FIG. 4 is another exemplary diagram illustrating a structure of a radio interface protocol on a user plane between the UE and a base station.

FIG. 5a is a flowchart illustrating a random access process in 3GPP LTE.

FIG. 5b illustrates a connection process in a radio resource control (RRC) layer.

FIG. 6a and FIG. 6b illustrate an architecture for connecting a WLAN to an EPC.

FIG. 7a is an exemplary diagram of the IFOM technology, and FIG. 7b is an examplary diagram of the MAPCON technology.

FIG. 8a and FIG. 8b illustrate network control entities for selecting an access network.

FIG. 9a and FIG. 9b illustrate examples of a method of handling a situation in which a UE roams from a home network to a visited network.

FIG. 10a illustrates an example of providing a newly defined RAN rule (RAN assistance information) to a UE in addition to an ANDSN policy, and FIG. 10b illustrates an example of selecting any one of a RAN rule (RAN assistance information) and policy information from an ANDSF when both of them are provided to the UE.

FIG. 11 illustrates a process of selecting any one of a UE-initiated mode and a network-initiated mode.

FIG. 12 illustrates an example in which a UE is moved to indicate a problem of a network-initiated NBIFOM mode.

FIG. 13 is a signal flowchart illustrating a procedure of performing NBIFOM according to a network initiation of the present specification.

FIG. 14 is a signal flowchart illustrating an exemplary procedure of performing NBIFOM according to a network initiation of the present specification.

FIG. 15 illustrates a procedure for performing network-initiated NBIFOM on the basis of a UE location and a presence reporting area configured in an MME 510.

FIG. 16 is a block diagram of a UE 100 and an MME 510 according to one disclosure of the present specification.

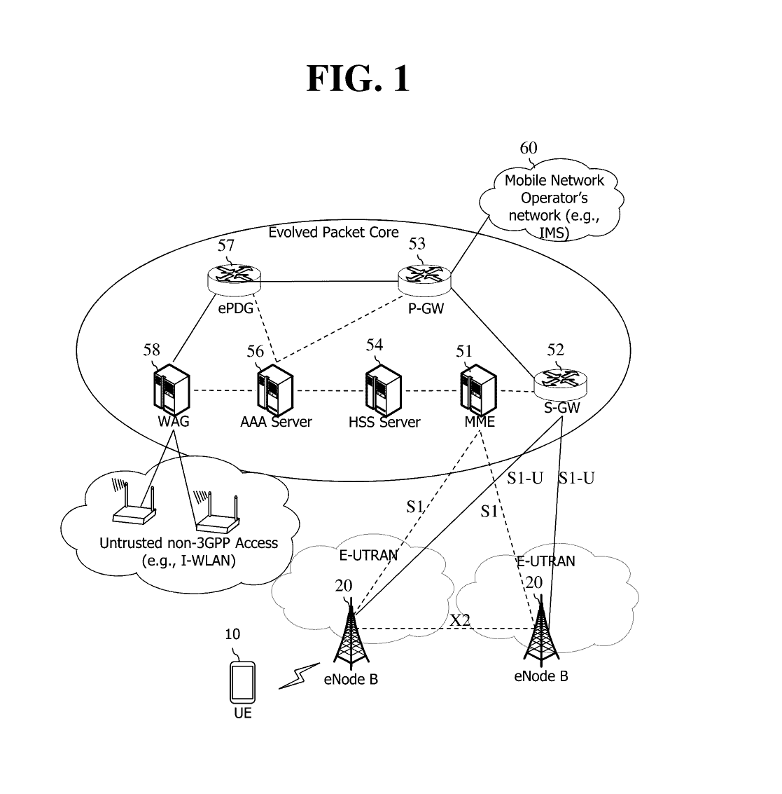

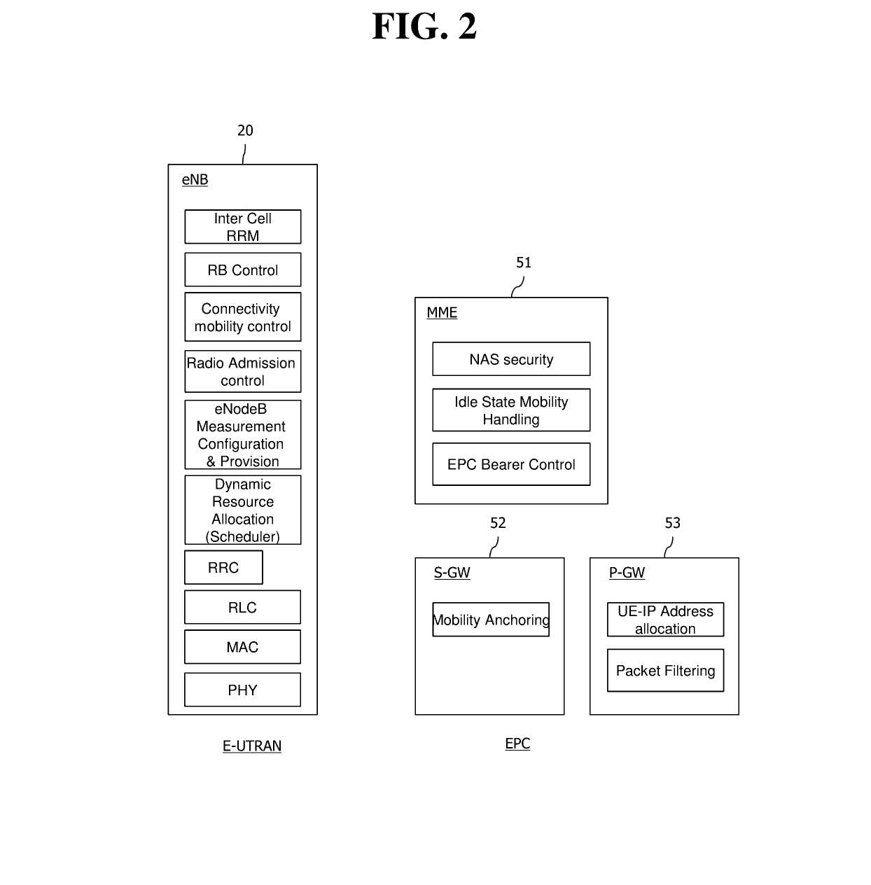

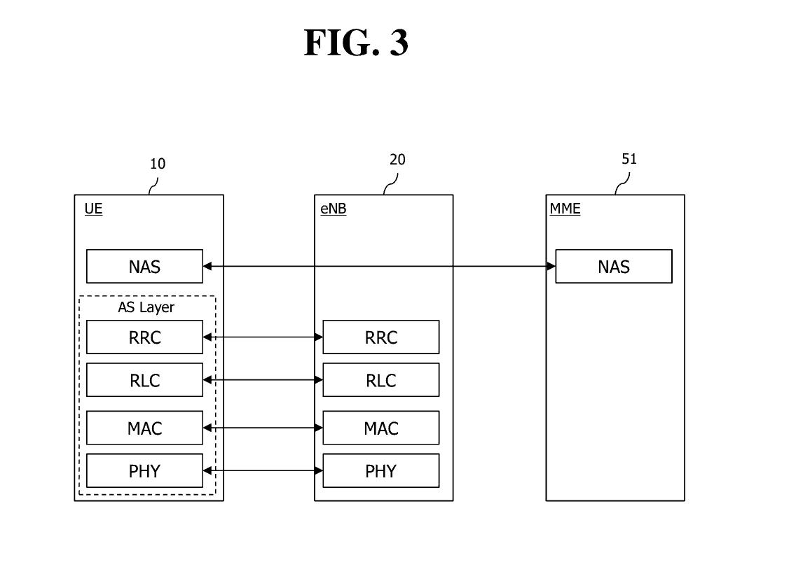

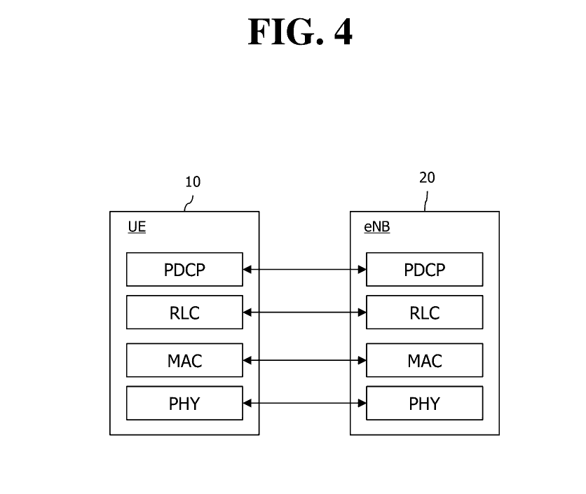

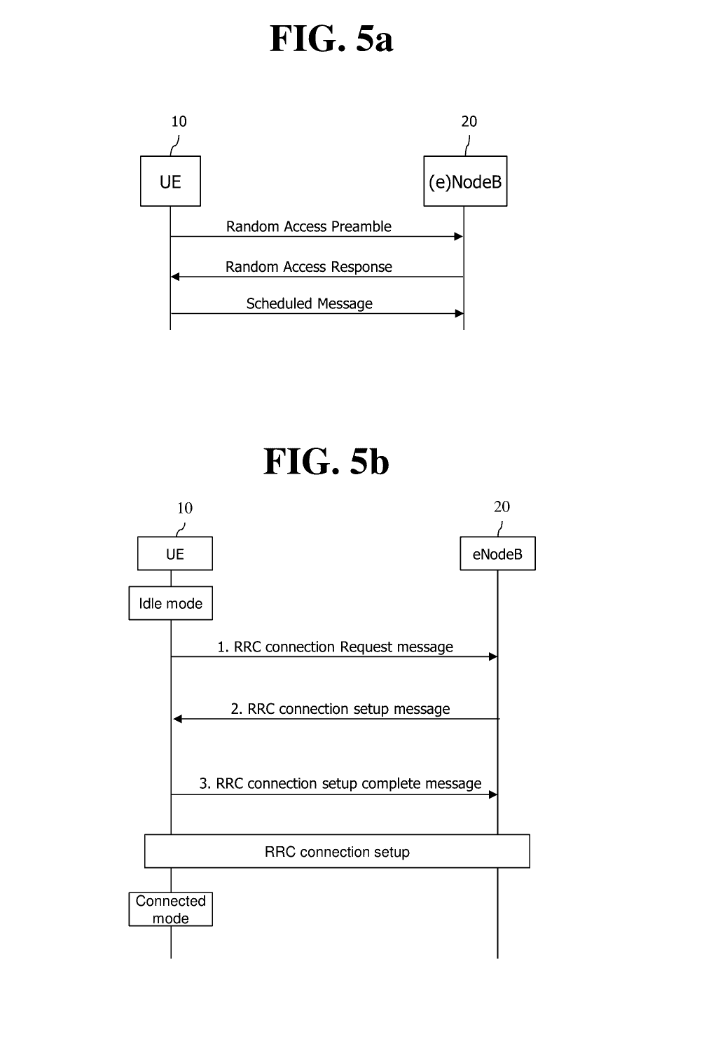

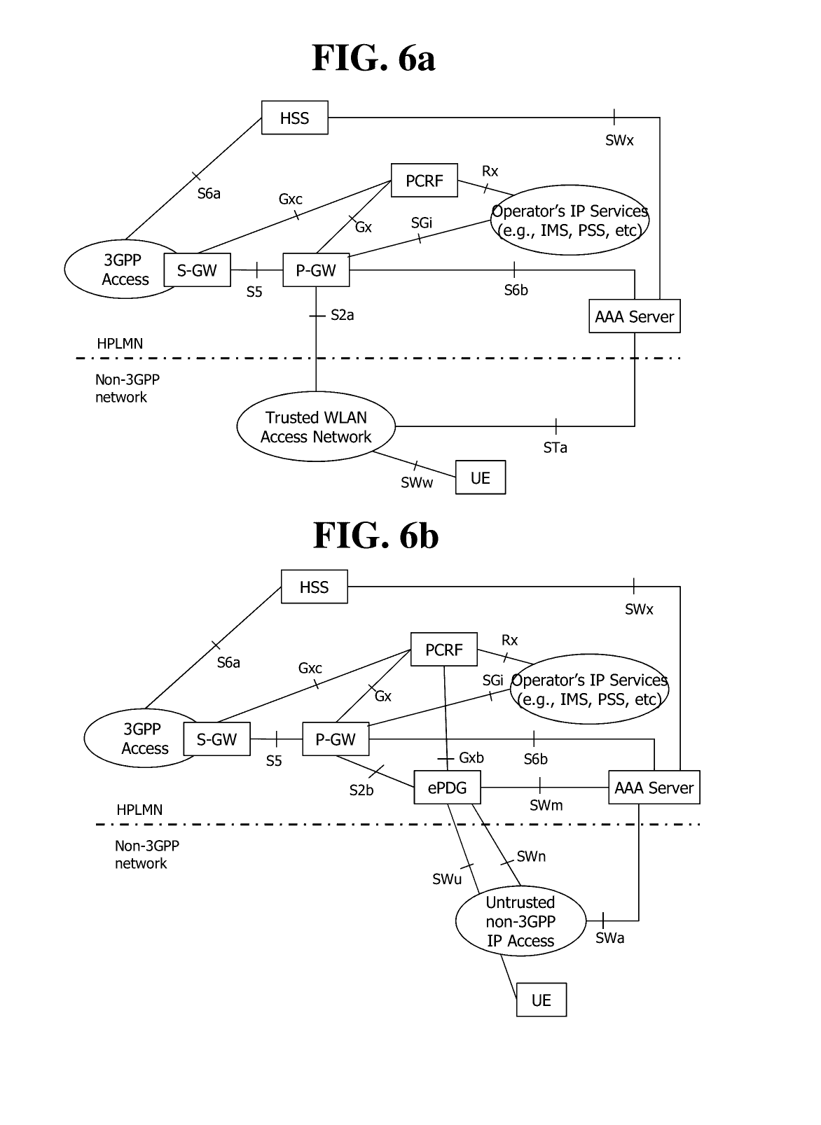

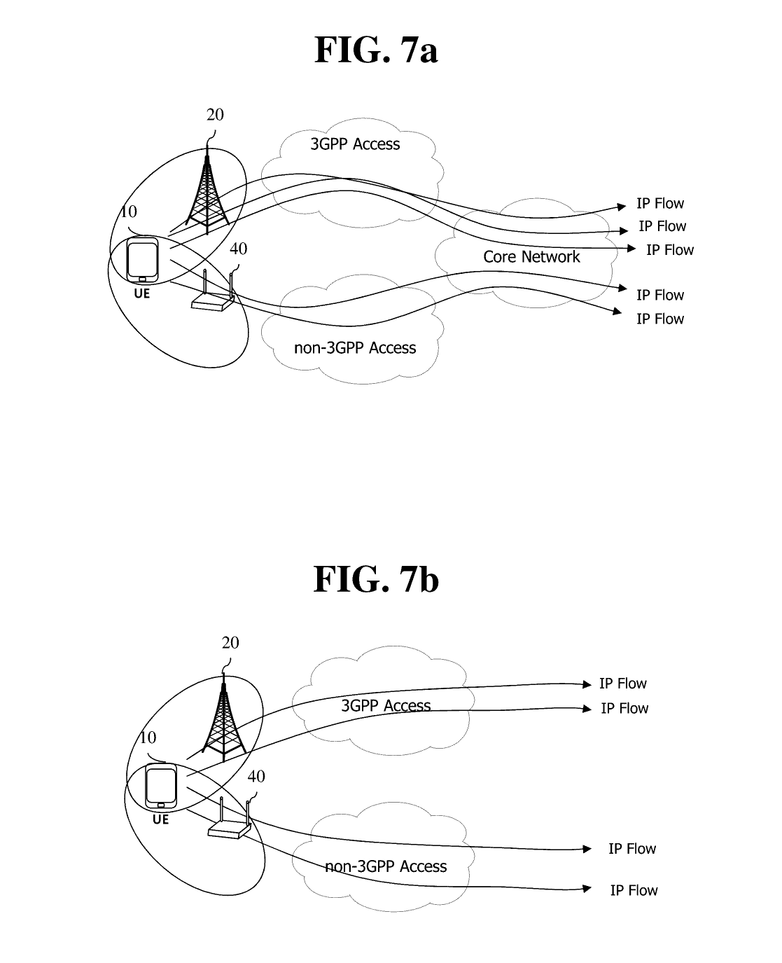

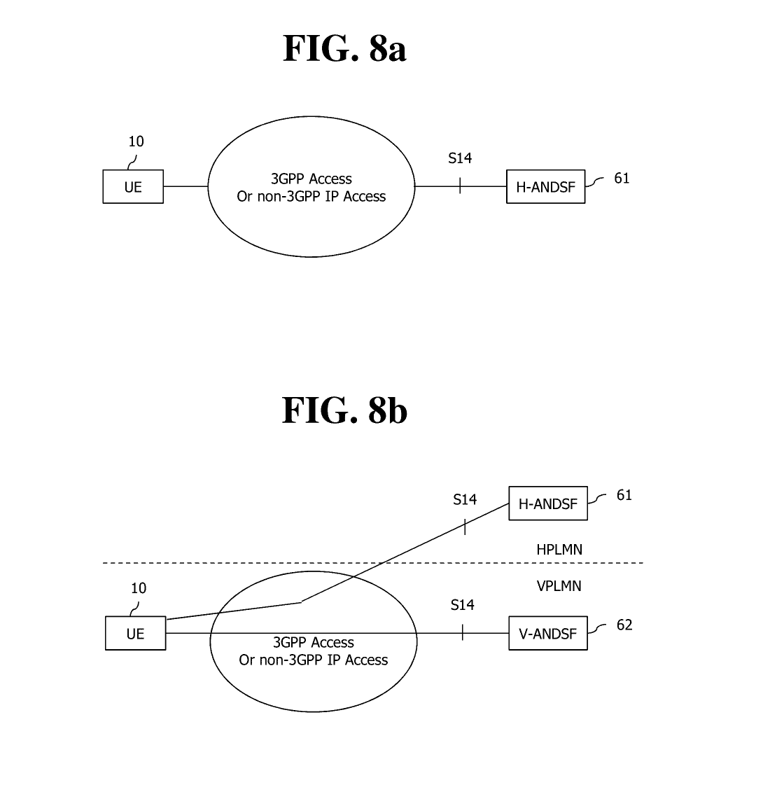

### DESCRIPTION OF EXEMPLARY EMBODIMENTS

The present invention is described in light of UMTS (Universal Mobile Telecommunication System) and EPC (Evolved Packet Core), but not limited to such communication systems, and may be rather applicable to all communication systems and methods to which the technical spirit of the present invention may apply.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

In the drawings, user equipments (UEs) are shown for example. The UE may also be denoted a terminal or mobile equipment (ME). The UE may be a laptop computer, a mobile phone, a PDA, a smartphone, a multimedia device, or other portable device, or may be a stationary device such as a PC or a car mounted device.

### DEFINITION OF TERMS

For a better understanding, the terms used herein are briefly defined before going to the detailed description of the invention with reference to the accompanying drawings.

A GERAN is an abbreviation of a GSM EDGE Radio Access Network, and it refers to a radio access section that connects a core network and UE by GSM/EDGE.

A UTRAN is an abbreviation of a Universal Terrestrial Radio Access Network, and it refers to a radio access section that connects the core network of the 3rd generation mobile communication and UE.

An E-UTRAN is an abbreviation of an Evolved Universal Terrestrial Radio Access Network, and it refers to a radio access section that connects the core network of the 4th generation mobile communication, that is, LTE, and UE.

An UMTS is an abbreviation of a Universal Mobile Telecommunication System, and it refers to the core network of the 3rd generation mobile communication.

UE or an MS is an abbreviation of User Equipment or a Mobile Station, and it refers to a terminal device.

An EPS is an abbreviation of an Evolved Packet System, and it refers to a core network supporting a Long Term Evolution (LTE) network and to a network evolved from an UMTS.

A PDN is an abbreviation of a Public Data Network, and it refers to an independent network where a service for providing service is placed.

A PDN connection refers to a connection from UE to a PDN, that is, an association (or connection) between UE represented by an IP address and a PDN represented by an APN.

A PDN-GW is an abbreviation of a Packet Data Network Gateway, and it refers to a network node of an EPS network which performs functions, such as the allocation of a UE IP address, packet screening & filtering, and the collection of charging data.

A Serving gateway (Serving GW) is a network node of an EPS network which performs functions, such as mobility anchor, packet routing, idle mode packet buffering, and triggering an MME to page UE.

A Policy and Charging Rule Function (PCRF) is a node of an EPS network which performs different QoS for each service flow and a policy decision for dynamically applying a charging policy.

An Access Point Name (APN) is the name of an access point that is managed in a network and provides to UE. That is, an APN is a character string that denotes or identifies a PDN. Requested service or a network (PDN) is accessed via a P-GW. An APN is a name (character string, e.g., ‘internet.mnc012.mcc345.gprs’) previously defined within a network so that the P-GW can be searched for.

A Tunnel Endpoint Identifier (TEID) is an end point ID of a tunnel set up between nodes within a network and is set in each section as a bearer unit of each terminal.

A NodeB is an eNodeB of a UMTS network and installed outdoors. The cell coverage of the NodeB corresponds to a macro cell.

An eNodeB is an eNodeB of an Evolved Packet System (EPS) and is installed outdoors. The cell coverage of the eNodeB corresponds to a macro cell.

An (e)NodeB is a term that denotes a NodeB and an eNodeB.

An MME is an abbreviation of a Mobility Management Entity, and it functions to control each entity within an EPS in order to provide a session and mobility for UE.

A session is a passage for data transmission, and a unit thereof may be a PDN, a bearer, or an IP flow unit. The units may be classified into a unit of the entire target network (i.e., an APN or PDN unit) as defined in 3GPP, a unit (i.e., a bearer unit) classified based on QoS within the entire target network, and a destination IP address unit.

A PDN connection is a connection from UE to a PDN, that is, an association (or connection) between UE represented by an IP address and a PDN represented by an APN. It means a connection between entities (i.e., UE-PDN GW) within a core network so that a session can be formed.

UE context is information about the situation of UE which is used to manage the UE in a network, that is, situation information including an UE ID, mobility (e.g., a current location), and the attributes of a session (e.g., QoS and priority)

A Non-Access-Stratum (NAS) is a higher stratum of a control plane between UE and an MME. The NAS supports mobility management and session management between UE and a network, IP address maintenance, and so on.

RAT is an abbreviation of Radio Access Technology, and it means a GERAN, a UTRAN, or an E-UTRAN.

Local Operating Environment Information: This is a set of implementation specific parameters which describe the local environment in which the UE is operating.

Presence Reporting Area: This is an area defined to report the presence of a UE in a 3GPP packet domain for the reasons of policy control and/or accounting or the like. In case of E-UTRAN, the presence reporting area consists of adjacent or not-adjacent tracking areas or a set of eNodeBs and/or cells. There are two types of presence reporting areas. One is a UE-dedicated presence reporting area, and the other is a presence reporting area predetermined by a core network.

ANDSF (Access Network Discovery and Selection Function): This is one of network entities for providing a policy for discovering and selecting an access that can be used by a UE on an operator basis.

ISRP (Inter-System Routing Policy): This is a rule defined by the operator to indicate which one will be used by the UE for routing of IP traffic among several radio access interfaces. The ISRP may include three types of rules as follows, as a policy for defining an access network preferred (i.e., having a high priority) or restricted to route/steer a packet service (or an IP flow or IP traffic or applications). That is, the ISRP may be divided into an IP flow mobility (IFOM) rule, a multi access PDN connectivity (MAPCON) rule, and a non-seamless WLAN offload (NSWO) rule as follows.
IFOM (IP Flow Mobility) rule: This rule is in regards to a list in which access technologies/access networks to be used by the UE are arranged according to a priority, when traffic matched to a specific IP traffic filter can be routed on a specific APN or on any APN. Further, this rule may designate for which radio access the traffic matched to the specific IP traffic filter is limited on the specific APN or on the any APN.
MAPCON (Multi Access PDN Connectivity) rule: This rule is a list in which the access technologies/access networks to be used by the UE are arranged according to the priority when a PDN connection for the specific APN can be routed. Further, this rule may designate for which radio access a PDN connection to a specific APN will be limited.
NSWO(Non-seamless WLAN offload) rule: This rule designates whether certain traffic will be offloaded or not offloaded non-seamlessly to a WLAN.

ISMP (Inter-System Mobility Policy): This is a set of rules defined by an operator to have an impact on an inter-system mobility decision made by the UE. When the UE can route IP traffic on a single radio access interface, the UE may use ISMP to select the most appropriate access technology type or access network in a given time.

RAN rule: This is to evaluate an RAN rule programmed in the UE and having radio access network (RAN) assistance parameters received from the network. The RAN rule is also called WLAN interworking supported by the RAN used without ANDSF ISRP/ISMP. When the RAN rule for moving traffic to the WLAN is satisfied, an access stratum (AS) layer of the UE delivers a move-traffic-to-WLAN indication and a WLAN identifier together to a higher layer of the UE. In this case, the UE selects the WLAN and moves all offloadable PDN connections to the WLAN. Alternatively, when the RAN rule for moving the traffic to the 3GPP access is satisfied, the AS layer of the UE delivers a move-traffic-from-WLAN indication to the higher layer of the UE. In this case, the UE moves all PDN connections on the WLAN through 3GPP. 3GPP TS 23.401, TS 23.060, TS 23.402, TS 36.300, TS 36.304, TS 36.331, TS 25.304, and TS 25.331 may be incorporated herein by reference to know detailed descriptions on the RAN rule.

Multi-access PDN connection: This is a PDN connection in which traffic can be routed to the 3GPP access and/or the WLAN access. Each IP flow is routed only to one access at one instance.

Meanwhile, the present invention is described hereinafter with reference to the accompanying drawings.

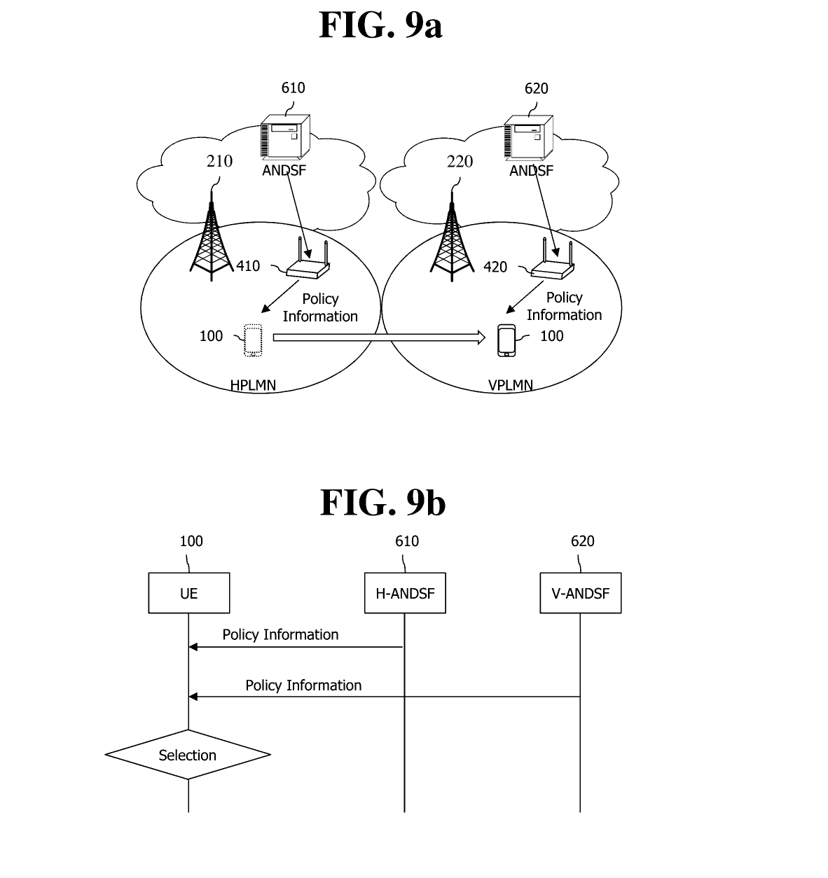

FIG. 9a and FIG. 9b illustrate examples of a method of handling a situation in which a UE roams from a home network to a visited network.

As can be seen with reference to FIG. 9a and FIG. 9b, when a UE 100 receives policy information from an H-ANDSF 610 in a home network (HPLMN) and thereafter roams to a visited network (VPLMN), additional policy information is received from a V-ANDSF 620.

Herein, the policy information may include an inter-system mobility policy (ISMP), an inter-system routing policy (ISRP), an inter APN routing policy (IARP), and a WLAN selection policy (WLANSP).

As such, when the UE 100 has the policy information from the two networks (PLMN), the UE 100 may apply IFOM by preferentially using information of any one policy.

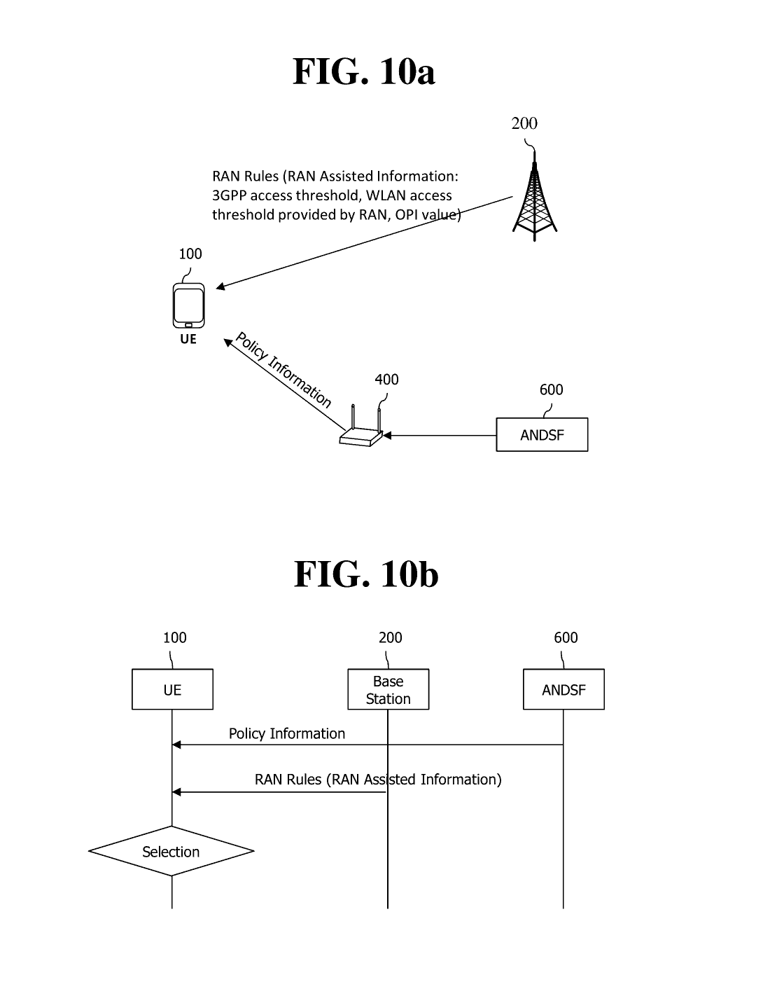

FIG. 10a illustrates an example of providing a newly defined RAN rule (RAN assistance information) to a UE in addition to an ANDSN policy, and FIG. 10b illustrates an example of selecting any one of a RAN rule (RAN assistance information) and policy information from an ANDSF when both of them are provided to the UE.

Although a UE 100 may receive policy information from an ANDSF 600 as shown in FIG. 10a, radio access network (RAN) assistance information may be received from an eNodeB 200 of an E-UTRAN (or UTRAN) to apply an RAN rule.

The RAN assistance information may include the following threshold and parameter.
3GPP access threshold
WLAN access threshold
Offload preference indication (OPI) value

The 3GPP access threshold defines some UTRA and/or E-UTRA radio parameters, for example, a low/high RSRP threshold for the E-UTRA and a low/high CPICH Ec/No threshold for the UTRA. The WLAN access threshold defines low/high thresholds for some WLAN access parameters, for example, a low/high beacon RSSI threshold, a low/high UL/DL backhaul data rate threshold, and a low/high channel utilization threshold. The UL/DL backhaul data rate is defined in hotspot 2.0. The channel utilization and the beacon RSSI are defined in IEEE 802.11.

The OPI value provided by the RAN has a bitmap format (i.e., a first-order bit arrangement) and is used to determine when the UE will move specific traffic (e.g., specific IP flow) to the WLAN access or the 3GPP access.

WLAN network selection and usage preferences for traffic routing may take precedence over the ANDSF rule and the RAN rule.

Meanwhile, as can be with reference to FIG. 10b, when the UE 100 has both of the RAN rule and the policy information from the ANDSF, any one of them may be preferentially used.

As described above, the IFOM is performed based on a decision primarily made by the UE, and uses a dual stack mobile IP (DSMIP) which is a host-based mobility protocol.

Meanwhile, a technology for providing the IFOM through the S2a and S2b interfaces using GTP or PMIP which is a network-based protocol is called network based IP flow mobility (NBIFOM). In the NBIFOM, the UE supports the 3GPP access and the WLAN access. The NBIFOM may be classified into UE-initiated NBIFOM and network-initiated NBIFOM according to which one performs triggering first.

UE-initiated NBIFOM: Mapping desired by the UE between IP flows and access links can be provided to the P-GW. In this case, the network can only accept or reject IP flow mobility of the UE, and the network cannot autonomously initiate the IP flow mobility.

Network-initiated NBIFOM: Mapping desired by the network between the IP flows and the access links can be provided to the UE. In this case, the UE can only accept or reject the IP flow mobility by the network, and cannot autonomously initiate the IP flow mobility.

Meanwhile, during the discussion on the NBIFOM, whether the UE-initiated NBIFOM and the network-initiated NBIFOM can be interchangeably used for one PDN connection has been discussed. As a result, it is proposed a method of using only one mode for one PDN connection.

First, an operation mode of the NBIFOM will be described.

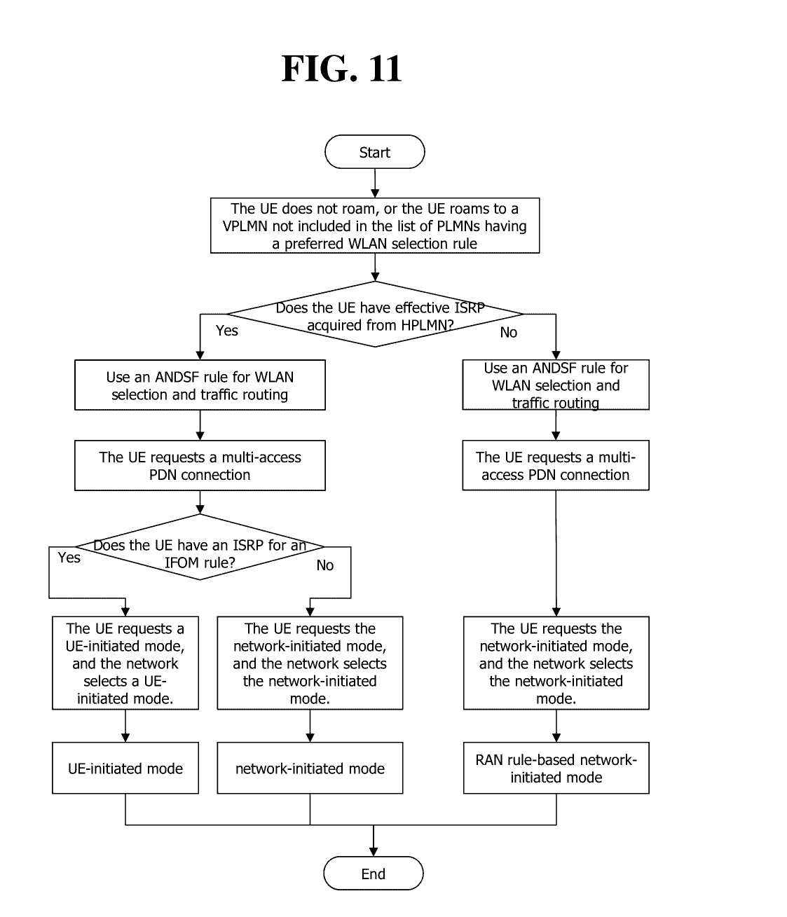

A multi-access PDN connection can operate in a UE-initiated mode or a network-initiated mode. A mode selection is performed when the PDN connection is established, and is maintained as long as the PDN connection is in an active state. Hereinafter, how to select the operation mode and what is a characteristic of each mode will be described with reference to FIG. 11.

FIG. 11 illustrates a process of selecting any one of a UE-initiated mode and a network-initiated mode.

Referring to FIG. 11, When a UE for which NBIFOM is enabled requests a PDN connection, a selection of an operation mode is initiated. In a situation where the UE does not roam to a VPLMN or in a case where the UE roams to the VPLMN not included in a list of PLMNs having a preferred WLAN selection rule, it is decided whether the UE has an effective ISRP acquired from the HPLMN.

If the UE has the effective ISRP, it is determined to use an ANDSF rule for the WLAN selection and the traffic routing. Subsequently, if the UE requests the multi-access PDN connection, it is decided whether the UE has the ISRP for the IFOM rule. If the UE has the ISRP for the IFOM rule, the UE requests the UE-initiated mode. Then, the network selects the UE-initiated mode. However, if the UE does not have the ISRP for the IFOM rule, the UE requests the network-initiated mode. Then, the network selects the network-initiated mode.

Meanwhile, if the UE does not have the effective ISRP, it is determined to use the RAN rule for the WLAN selection and the traffic routing. Subsequently, if the UE requests the multi-access PDN connection, the UE requests the network-initiated mode. Then, the network selects the network-initiated mode.

If the UE for which the NBIFOM is enabled roams to the VPLMN included in the list of the PLMNs having the preferred WLAN selection rule, it is decided whether the UE has an effective ISRP acquired from not the HPLMN but the VPLMN when a first condition is decided in FIG. 11. Other operations are the same as described above.

Meanwhile, a UE-initiated NBIFOM mode will be described below in greater detail.

In the UE-initiated mode, the UE may apply the IFOM rule and/or the user-configuration routing rule from an ANDSF of the UE to steer traffic routing in the multi-access PDN connection. Herein, if the UE has the effective ANDSF rule for NSWO, IARP, and/or MAPCON, the UE may also steer traffic routing not included in the multi-access PDN connection.

The UE may move an IP flow selected by the UE in the PDN connection from a previous access to a new access by transmitting the routing rule to the network. The routing rule transmitted by the UE may designate a specific IP flow and the new access.

The network may reject the IP movement request from the UE on the basis of subscriber information. When the network rejects the request from the UE, the network may provide a cause value indicating why the request is rejected. The cause value may allow the UE to determine whether the IP flow mobility can be requested again, and further, if so, when it can be requested again.

On the other hand, the network-initiated NBOFOM mode will be described below.

In the network-initiated mode, the UE does not have the routing rule that can be used for the IP flow mobility. In this network-initiated mode, the network may steer the traffic routing in the multi-access PDN connection. However, if the UE has the effective ANDSF rule for NSWO, IARP, and/or MAPCON, the UE may steer external traffic routing of the multi-access PDN connection.

The network may move an IP flow selected by the network in the PDN connection from a previous access to a new access by transmitting the routing rule to the UE. The routing rule transmitted by the network may designate a specific IP flow and the new access.

The UE may reject the IP movement request from the network. When the UE rejects the request from the network, the UE may provide a cause value indicating why the request is rejected. The cause value may allow the network to determine whether the IP flow mobility can be requested again, and further, if so, when it can be requested again.

Although the UE cannot request the IP flow mobility, when an access of the multi-access PDN connection can be used for traffic routing or when it cannot be used, the UE may report this to the network.

This is as follows for example.
When the UE has lost a WLAN signal and when the UE has an activated IP on the WLAN, the UE may transmit to the network an indication indicating that the WLAN cannot be used for traffic routing. The UE and the network may route again one or more of such IP flows to the 3GPP.
When the UE discovers the WLAN signal again, if the existing routing role in the UE requests to route some IP flows to the WLAN, the UE may transmit to the network an indication indicating that the WLAN can be used again.
The UE may follow an operating environment of the UE to determine when the indication will be transmitted.

Meanwhile, if the UE has the RAN rule (i.e., RAN assistance information) indicating when traffic is routed to the WLAN or the 3GPP, the UE may operate as follows.
If the RAN rule of the UE indicates that traffic must be moved to the 3GPP, the UE may transmit an indication indicating that the WLAN cannot be used for traffic routing to the network.
If the RAN rule of the UE indicates that traffic must be moved to the WLAN, the UE may transmit an indication indicating that the WLAN can be used for traffic routing to the network.
If the RAN rule of the UE does not provide an offload preference (e.g., if it does not indicate a movement to the 3GPP or the WLAN), traffic routing in a PDN connection may be performed according to the routing rule provided by the network.

The UE-initiated NBIFOM and the network-initiated NBIFOM have been described above.

However, there is no conventional method for the network-initiated NBIFOM, and no specific method has been proposed until now.

Further, conventionally, in order for the UE to provide the network with a routing rule for IP flow mobility, a NAS message is primarily used. The NAS message needs to be passed through many network nodes (e.g., MME, S-GW, P-GW), which causes an increase in an overload.

On the other hand, as described above, if the UE does not have an effective ISRP rule as to a mode selection, or even if there is the ISRP rule, if the UE does not have an IFOM rule, the UE requests the network-initiated NBIFOM mode. However, the network-initiated NBIFOM mode has a disadvantage in that the IP flow mobility cannot be performed in the network on the basis of a UE location.

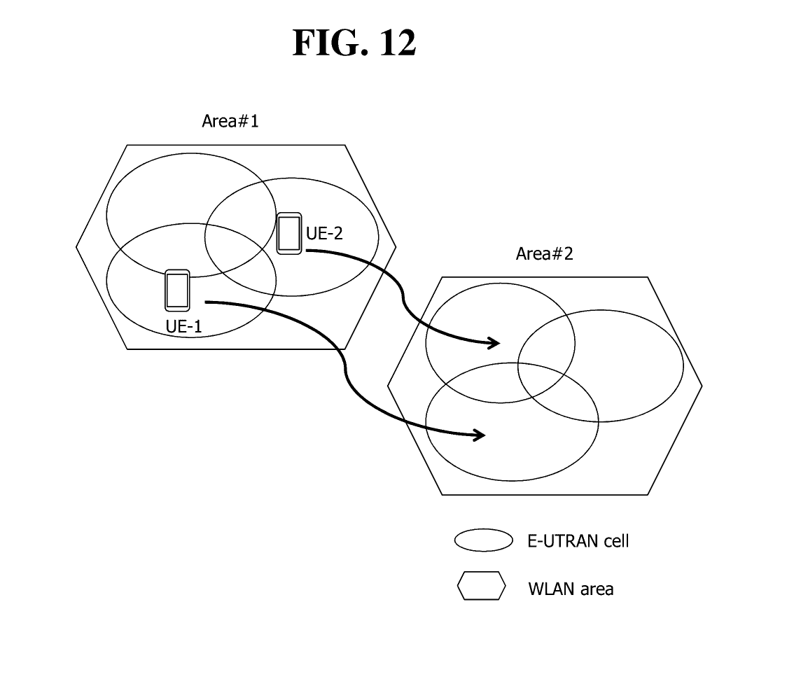

This will be described below in greater detail with reference to FIG. 12.

FIG. 12 illustrates an example in which a UE is moved to indicate a problem of a network-initiated NBIFOM mode.

It is assumed in FIG. 12 that a scenario of routing an IP flow to a WLAN desired by a network is as follows.
An IP flow#1 is routed to the WLAN if a UE-1 is located in an area#1.
The IP flow#1 is routed to 3GPP if the UE-1 is located in an area#2 (That is, it is not routed to the WLAN).
The IP flow#1 is routed to the 3GPP if a UE-2 is located in the area#1 (That is, it is not routed to the WLAN).
The IP flow#1 is routed to the WLAN if the UE-2 is located in the area#2.

Such a scenario is used, for example, when an operator intends to offload traffic of a special user to a high-performance WLAN in the area#1 and to offload traffic of general users to a general-performance WLAN to distribute traffic of the 3GPP network in the area#2 corresponding to a downtown area in which many users are concentrated.

If the network has transmitted routing information to the UE-1 to route the IP flow#1 to the WLAN, the UE-1 routes the IP flow#1 to the WLAN in the area#1. Thereafter, the UE-1 is moved to the area#2 and thus routes the IP flow#1 to the WLAN on the basis of routing information received from the network. However, this is an operation not desired in the network. Further, it is assumed that the UE-2 has not yet received the routing information for the IP flow#1 from the network or has received routing information instructing to route the IP flow#1 to the 3GPP. In the area#1, the UE-2 routes the IP flow#1 to the 3GPP. Thereafter, even if the UE-2 is moved to the area#2, the UE-2 still routes the IP flow#1 to the 3GPP. Also, this is an operation not desired in the network.

That is, problematically, it is impossible to perform the NBIFOM operation in the network on the basis of the UE location.

Therefore, there is a need for a method for performing the NBIFOM operation effectively on the basis of the UE location also in the network-initiated NBIFOM mode.

<Disclosure of the Present Specification>

The following description is about a mechanism for effectively providing IP flow mobility between a 3GPP access network and a WLAN access network in a mobile communication system such as a 3GPP evolved packet system (EPS). An IP flow mentioned hereinafter may imply traffic, packets, data IP services, applications, etc., and these terms may be used interchangeably.

I. Method of Exchanging an IP Flow Mobility Related Message and/or Information Between a UE and a Network

The IP flow mobility related message and/or information may be exchanged between the UE and the network. Although the network implies a P-GW in general, the present invention is not necessarily limited thereto, and thus the network may be various network nodes participating in IP flow mobility. However, the P-GW is mainly described hereinafter. This is applied throughout the present specification.

The UE and the P-GW exchange the IP flow mobility related message and/or information through a WLAN access network. This implies that the IP flow mobility related message and/or information is not exchanged through a 3GPP access network but is exchanged through only the WLAN access network. However, in a case where the UE cannot use the WLAN access network (for example, a case where a WLAN signal is not received since the UE is out of a WLAN coverage while using the WLAN access network), the IP flow mobility related message and/or information may be exchanged through the 3GPP access network. For this, a NAS message may be newly defined or may be extendedly used. By reference, the IP flow mobility related message and/or information directly have an effect on IP flow mobility as shown in the following operation. Accordingly, capability/assistance information exchanged between the UE and the network to operate/perform IP flow mobility can be exchanged through the 3GPP access network.
PDN connection establishment over first access
Addition of an access to a PDN connection
IP flow mobility within a PDN connection
Removal of an access from a PDN connection

When the UE and the P-GW exchange the UP flow mobility related message and/or information through the WLAN access network, the following path may be required.

1) In an architecture in which the WLAN is connected to a P-GW through the S2a interface (hereinafter, simply referred to as an S2a scenario), a UE and TWNA duration and a TWAN and P-GW duration are required.

In the UE and TWAN duration, a WLAN control protocol (WLCP) defined in Release 12 may be used to exchange the IP flow mobility related message and/or information. In this case, the conventional WLCP message may be used, and a new WLCP message may be defined and used. In case of using the conventional WLCP message, a new information element (IE) may be defined and used, and may be extendedly used by defining a new value/type in the conventional IE. Alternatively, in the UE and TWAN duration, an EAP-AKA message may be used to exchange the IP flow mobility related message and/or information. In this case, likewise, the conventional EAP-AKA message may be reused or extendedly used. Alternatively, a new type of a protocol message may be defined and used.

In the TWAN and P-GW duration, a GTP or a PMIP is used according to an architecture. In this case, the conventional GTP or PMIP message may also be reused or extendedly used to exchange the IP flow mobility related message and/or information. That is, the conventional GTP or PMIP message may be used, and a new GTP or PMIP message may be defined and used. In case of using the conventional GTP or PMIP message, a new information element (IE) may be defined and used, and may be extendedly used by defining a new value/type in the conventional IE.

2) An architecture in which the WLAN is connected to the P-GW through the S2b interface via an ePDG (hereinafter, simply referred to as an S2b scenario) has a UE and ePDG duration and an ePDG and P-GW duration.

In the UE and ePDG duration, a new type of a protocol message for performing session management such as a WLAN control protocol (WLCP) may be defined and used to exchange the IP flow mobility related message and/or information. Alternatively, in the UE and ePDG duration, an IKEv2 message may be used to exchange the IP flow mobility related message and/or information. In this case, the conventional IKEv2 message may be reused or extendedly used.

In the ePDG and P-GW duration, a GTP or a PMIP is used according to an architecture. In this case, the conventional GTP or PMIP message may also be reused or extendedly used to exchange the IP flow mobility related message and/or information. That is, the conventional GTP or PMIP message may be used, and a new GTP or PMIP message may be defined and used. In case of using the conventional GTP or PMIP message, a new information element (IE) may be defined and used, and may be extendedly used by defining a new value/type in the conventional IE.

Meanwhile, a representative example of the IP flow mobility related information may include a routing rule. In the UE-based IFOM standardized in 3GPP Rel-10, the routing rule is an association between a routing filter and a routing address. The routing filter and the routing address are defined as follows.

Routing filter: A set of packet flow IP header parameter values/ranges used to identify one or more IP flows for routing purposes.

Routing address: A routable address. In DSMIPv6, this is expressed as either care-of-address (CoA) or HoA.

The network-based IFOM is different from the UE-based IFOM, i.e., NBIFOM, in a sense that the same IP address information is allocated/used if the same PDN connection is used in both of a case of using the PDN connection through the 3GPP access network and a case of using the PDN connection through the WLAN. Therefore, the aforementioned routing address constituting the routing rule needs to be replaced with another type of information. Accordingly, information indicating/identifying a routing access network class/type (or routing access type or access type or RAT type) may be used. For example, values for identifying the 3GPP access network and the WLAN access network may be used. In case of storing routing information for supporting IP flow mobility for the UE (or routing table or routing mapping table or binding cache or routing rule information) in the P-GW, a routing access network class/type may be stored, or gateway address information of a corresponding routing access network may be stored instead of routing access network class/type information, and the gateway address information of the corresponding routing network may be stored together with the routing access network class/type information. Herein, the gateway address information of the corresponding routing access network is address information of an S-GW in case of the 3GPP access network, is address information of a TWAN (or trusted WLAN access gateway (TWAG)) in case of the TWAN, and is address information of an ePDG in case of an untrusted WLAN.

Further, in the UE-based IFOM, an association between Care-Of-Addresses (CoA) allocated to the UE in a home address (IP address allocated to the UE in 3GPP access) and a WLAN access is mentioned as binding, and a binding identifier (BID) is allocated/designated in each blinding. Therefore, for each routing rule of routing information (or routing table or routing mapping table or binding cache or routing rule information) for supporting IP flow mobility stored by the UE and the P-GW, an identifier called BID may be allocated/used, and an identifier called a routing identifier (RID) may be allocated/used.

The routing filter information may be used by being modified/extended to a proper form for the present invention, on the basis of the content disclosed in 3GPP TS 23.261.

An example of routing information (or routing table or routing mapping table or binding cache or routing table information) is shown below.

TABLE 2

| | Routing | | | | |
|---|---|---|---|---|---|
| Routing | Access | RID | Flow | FID | |
| ID | Type | Priority | ID | Priority | Routing Filter |
| RID1 | 3GPP | x | FID1 | a | Description of IP flows . . . |
| | access | | FID2 | b | Description of IP flows . . . |
| RID2 | WLAN | y | FID3 | . . . | . . . |
| | access | | | | |

A primary operation for performing IP flow mobility between the UE and the P-GW may be an operation of adding/changing/removing routing rules by mutually exchanging the IP flow mobility related message and/or information. This may be a UE-initiated NBIFOM operation, and may be a network-initiated NBIFOM operation.

If the UE cannot use the WLAN access network as mentioned above, the IP flow mobility related message and/or information may be exchanged through the 3GPP access network. In this case, the UE may transmit, to the network, RID(s) and/or FID(s) information intended to be moved to the 3GPP access network. In addition, if a routing access type is designated as 3GPP access and thus the UE cannot use the WLAN access network, it may be recognized that some or all IP flows are moved to the 3GPP access in an implicit manner in the network instead of explicitly transmitting the IP flow mobility related message and/or information by the UE to the network. For example, it may be recognized that some or all IP flows are moved to the 3GPP access by recognizing that the IP flow transmitted by the UE is being transmitted through not the WLAN access but the 3GPP access, or by recognizing that the UE does no longer have access in the WLAN access network (or TWAN or ePDG) to which the UE has accessed and reporting this through the 3GPP access.

II. Operation of Performing Network-Initiated NBIFOM.

A P-GW may allow IP flow mobility between a 3GPP access and a WLAN access network to be performed by a UE (or for the UE) on the basis of one or more pieces of information described below.

a) Load/congestion related information of 3GPP access network

The P-GW may collect the information from an eNodeB, or may collect the information from another network node. The load/congestion related information of the 3GPP access network may be provided in various forms for expressing a load/congestion. For example, the load/congestion related information may be expressed as a load/congestion level or may be expressed in a form of ‘congested/overloaded’ or ‘not congested/not overloaded’. The load/congestion related information transmitted by the eNodeB to the P-GW may be information for a specific UE (in concept of per-UE), and may be information in concept of per eNodeB irrespective of the specific UE. The information may be periodically transmitted, and may be transmitted if a certain load/congestion threshold is exceeded (that is, if the threshold is exceeded to be regarded as a congestion/overload situation) and if it is exceeded and then is decreased (that is, if the congestion/overload situation is released). Further details may adopt various mechanisms (see 3GPP TR 23.705) which are under research in user plane congestion management (UPCON) of 3GPP Rel-13.

b) Load/congestion related information of WLAN access network

In case of an S2a scenario, the P-GW may collect the information from the TWAN, and may collect the information from another network node. The load/congestion related information of the WLAN access network may be provided in various forms for expressing a load/congestion. For example, the load/congestion related information may be expressed as a load/congestion level or may be expressed in a form of ‘congested/overloaded’ or ‘not congested/not overloaded’. Further, the information may be load/congestion related information of a BSS and/or load/congestion related information of a backhaul to which a WLAN AP/TWAN is connected. The load/congestion related information transmitted by the TWAN to the P-GW may be information for a specific UE (in concept of per-UE), and may be information in concept of per eNodeB irrespective of the specific UE.

In case of an S2b scenario, the P-GW may collect the information from the ePDG, and may collect the information from another network node. The load/congestion related information of the WLAN access network may be provided in various forms for expressing a load/congestion. For example, the load/congestion related information may be expressed as a load/congestion level or may be expressed in a form of ‘congested/overloaded’ or ‘not congested/not overloaded’. Further, the information may be load/congestion related information or a BSS and/or load/congestion related information of a backhaul to which a WLAN AP/TWAN is connected. The load/congestion related information transmitted by the ePDG to the P-GW may be information for a specific UE (in concept of per-UE), and may be information in concept of per ePDG irrespective of the specific UE.

In both of the S2a scenario and the S2b scenario, the load/congestion related information of the WLAN access network may be transmitted periodically, and may be transmitted if a load/congestion threshold is exceeded (that is, if it is exceeded to be regarded as a congestion/overload situation) and if it is exceeded and then is decreased (that is, if the congestion/overload situation is released).

c) IP flow routing related policy and/or information (QoS information or the like) and/or decision provided from PCRF

d) Operator policy information

e) Local configuration information

f) Whether it is possible to access a WLAN access network in a UE location (that is, whether an available WLAN access network is present around the UE)

This information may be acquired from the UE or may be acquired from another network node. The P-GW/PCRF may request the MME to provide a location report in order to acquire UE location information. Accordingly, whether an available WLAN access network is present can be known on the basis of the acquired UE location information (e.g., TAI, ECGI, service area identification (SAD, etc.). For example, it can be known by utilizing a mapping table/database between an ECG1 and the WLAN access network since the P-GW/PCRF have the mapping table/database. Further, the P-GW/PCRF may configure an area in which WLAN access network is available as a presence reporting area, and then may request the MME to provide a location report based on the configuration of the presence reporting area. In this case, when the UE is in the configured presence reporting area or enters therein, and when the UE is outside the configured presence reporting area or exits therefrom, the UE may receive the location report from the MME. Accordingly, by utilizing this, whether the UE is capable of having access to the WLAN access network at a current location can be determined.

Further, the P-GW/PCRF may request the MME to provide the location report only when the UE is in a connected mode (or when one or more E-RABs are established for a PDN connection). In doing so, whether to perform IP flow mobility may be determined by acquiring UE location information only when there is actual traffic.

A detailed operation related to the aforementioned location report adopts the clause of 5.9.1 Location Reporting Procedure and the clause 5.9.2 Location Change Reporting Procedure of 3GPP TS 23.401.

g) Characteristic of IP flow and QoS information to be provided

h) Whether the UE is attached to the 3GPP access network

i) Whether the UE is attached to the WLAN access network

As an example in which the P-GW allows the IP flow mobility to be performed by the UE (or for the UE) on the basis of the aforementioned information a-i, in a case where the UE currently uses only the 3GPP access network and a 3GPP access network currently in use is in a congestion/overload situation and there is a WLAN(s) that can be used by the UE at a current location (in addition, the WLAN(s) is not in the congestion/overload situation), the P-GW may allow to use not the 3GPP access network but the WLAN access network as to an IP flow#1 of the UE. As another example in which the P-GW allows the IP flow mobility to be performed by the UE (or for the UE) on the basis of the aforementioned information, there is a case where the UE currently uses the 3GPP access network and the WLAN access network, and the WLAN access network is currently in use as to an IP flow#2 while the WLAN access network in use is in a congestion/overload situation. In this case, the P-GW may allow to use not the WLAN access network but the 3GPP access network as to the IP flow#2 of the UE.

Since the P-GW allows the IP flow mobility to be performed by the UE, the UE may perform the following operation.
Addition of a 3GPP access to a PDN connection
Addition of a WLAN access to a PDN connection
IP flow mobility from 3GPP access to WLAN access within a PDN connection
IP flow mobility from WLAN access to 3GPP access within a PDN connection
Removal of a 3GPP access from a PDN connection
Removal of a WLAN access from a PDN connection

When routing rules information to be added/changed/removed is provided to the UE so that the P-GW allows the IP flow mobility between the 3GPP access network and the WLAN access network to be performed by the UE, the following additional information may be provided.
Information which mandates or instructs the IP flow mobility to be necessarily performed by the UE according to a corresponding rule. For example, a “shall” information/value may be used.
Information which allows the IP flow mobility to be performed by the UE according to a corresponding routing rule if the IP flow mobility is possible and desirable by considering local operating environment information. For example, a “should” information/value may be used.
Information which allows that whether to perform the IP flow mobility according to a corresponding routing rule is determined by the UE on the basis of user preferences (when configured) if the IP flow mobility is possible and desirable by considering the location operating environment information. For example, a “may” information/value may be used.

The aforementioned information may be provided as one value for the provided routing rules, and if a plurality of routing rules are provided, different values may be provided for the respective rules. The latter case is, for example, a case where routing is achieved currently through the 3GPP access network as to IP flow(s) respectively corresponding to a routing filter#1 and a routing filter#2, and the P-GW provides information such that a routing rule for the routing filter#1 includes “shall” information and a routing rule for the routing filter#2 includes “may” information, while providing the UE with routing rules for routing the IP flow(s) through the WLAN access network.

Further, when the P-GW provides the UE with routing rules information to be added/changed/removed so that the IP flow mobility between the 3GPP access network and the WLAN access network is performed by the UE, information (e.g., an identifier or the like such as SSID) regarding an accessible (or available) WLAN access network may be provided. A variety of information including the aforementioned information a) to i) may be used as a criterion for selecting the available WLAN access network.

In addition, when the P-GW provides the UE with routing rules information as mentioned above, the information may be delivered through the WLAN access network as described in the above clause I. However, the present invention is not necessarily limited thereto, and thus the information may also be delivered through the 3GPP access network. In this case, the information is delivered to P-GW->S-GW->MME->UE, and for this, a NAS message is newly defined or extendedly used. Alternatively, the P-GW may report (explicitly or implicitly) to the UE that the routing rules information will be pulled, and upon receiving the report, the UE may acquire the routing rules information from the P-GW. A message/information used when the P-GW reports the UE that the routing rules information will be pulled and a message used when the UE acquires the routing rules information from the P-GW may be transmitted in such a manner that: both of them are transmitted through the 3GPP access network; the former is transmitted through the 3GPP access network and the latter is transmitted through the WLAN access network; the former is transmitted through the WLAN access network and the latter is transmitted through the 3GPP access network; and both of them are transmitted through the WLAN access network.

Although it is described above that the P-GW is a primary entity for determining to allow the IP flow mobility between the 3GPP access network and the WLAN access network to be performed by the UE (or for the UE), the P-GW may be a PCRF. In this case, the P-GW may perform a role of transmitting an IP flow mobility related message and/or information to the UE under the decision of the PCRF. Further, the P-GW and the PCRF may mutually exchange a variety of information related to the IP flow mobility.

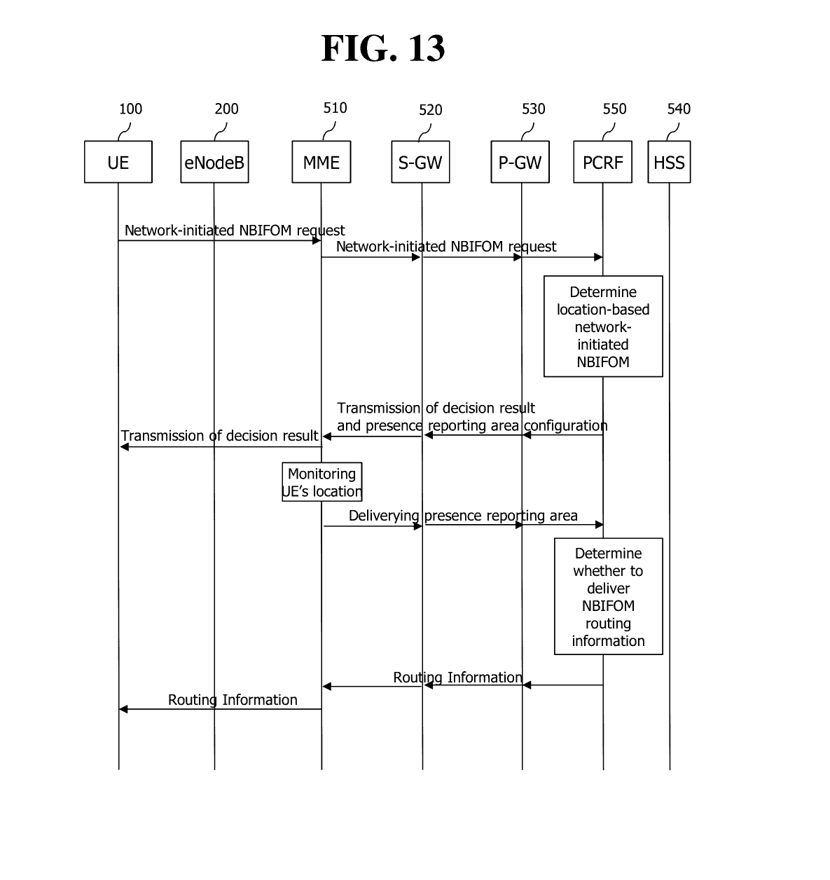

FIG. 13 is a signal flowchart illustrating a procedure of performing NBIFOM according to a network initiation of the present specification.

Referring to FIG. 13, a UE 100 delivers a network-initiated network based IP flow mobility (NBIFOM) request to an MME 510 through an eNodeB 200.

The MME 510 delivers the network-initiated NBIFOM request to a PCRF 550 through an S-GW 520 and a P-GW 530.

The PCRF 550 determines whether to perform the network-initiated NBIFOM based on a location according to the request.

In addition, if the PCRF 550 determines to perform the network-initiated NBIFOM based on the location, the decision result and a presence reporting area configuration are delivered to the MME 510 via the P-GW 530 and the S-GW 520.

Then, the MME 510 delivers the decision result to the UE 100, and thereafter monitors whether the UE 100 enters the configured presence reporting area or exits to the outside.

If it is confirmed that the UE 100 enters the configured presence reporting area, the MME 510 delivers presence reporting area information to the PCRF 550 through the S-GW 520 and the P-GW 530.

The PCRF 550 determines whether to deliver NBIFOM routing information, and thus delivers routing information to the MME 510 through the P-GW 530 and the S-GW 520.

Then, the MME 510 delivers the routing information to the UE 100.

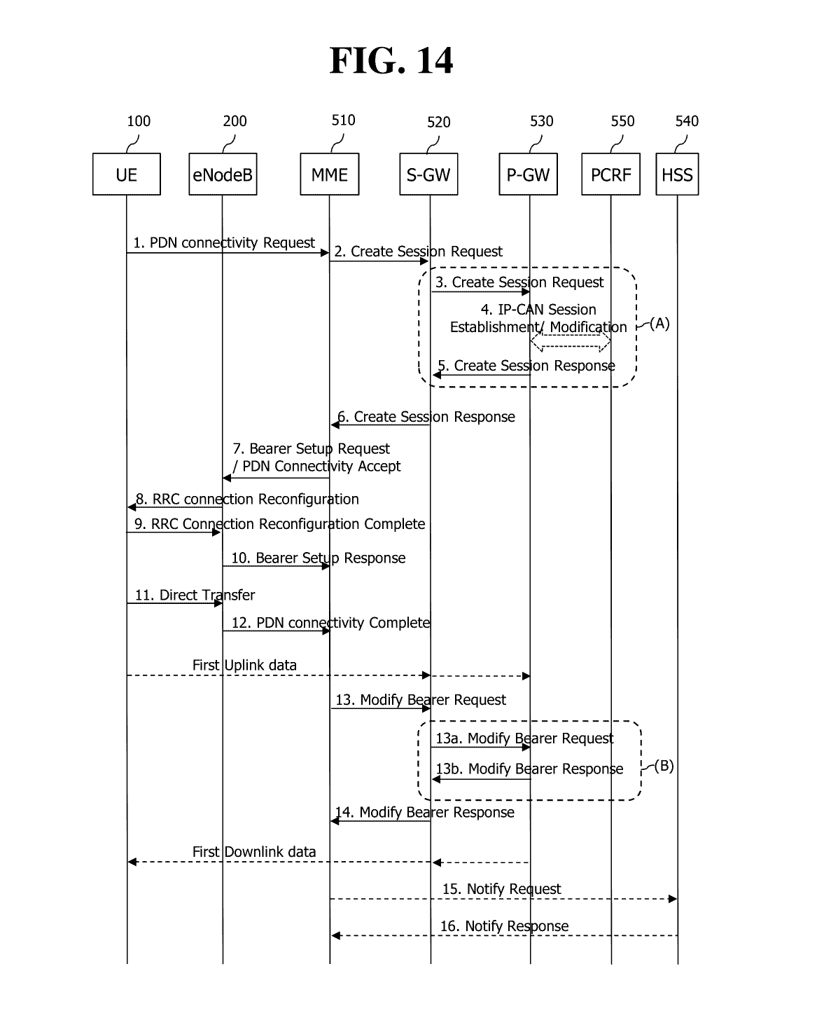

FIG. 14 is a signal flowchart illustrating an exemplary procedure of performing NBIFOM according to a network initiation of the present specification.

Referring to FIG. 14, a procedure for performing a network-initiated NBIFOM based on a location of a UE 100 by configuring a presence reporting area to an MME 510 is disclosed according to a network-initiated NBIFOM of the present specification. This is described below in greater detail.

1) The UE 100 transmits a PDN connectivity request message to the MME 510. In this case, the UE 100 requests a network to provide NBIFOM capability and a network-initiated NBIFOM mode. The NBIFOM capability may be implicitly expressed by only requesting the network-initiated NBIFOM mode instead of requesting the NBIFOM capability separately.

2) The MME 510 transmits a create session request message to the S-GW 520 according to the PDN connectivity request message.

3) Then, the S-GW 520 transmits the create session request message to the P-GW 530.

4) The P-GW 530 and the PCRF 550 perform a procedure of modifying an IP-CAN session establishment. During this procedure, the P-GW 530 transmits, to the PCRF 550, NBIFOM information received from the UE 100. In this case, the P-GW 530 transmits NBIFOM capability information received from the MME 510 and the S-GW 520 and NBIFOM capability information of the P-GW 530.

The PCRF 550 determines to drive the network-initiated NBIFOM mode for a corresponding PDN. This decision may be performed on the basis of information received from the P-GW 530 and subscriber information, operator policy, or the like acquired from an HSS. In particular, when the PCRF 550 decides to use the network-initiated NBIFOM mode based on the location, this decision is reported to the P-GW 530. In this case, the PCRF 550 transmits together a configuration of a presence reporting area corresponding to a WLAN area required to offload traffic of the UE 100 to the WLAN.

5) The P-GW 530 delivers a create session response message to the S-GW 520. In this case, the P-GW 530 may allow the create session response message to contain information for reporting that the network-initiated NBIFOM mode is used and/or information for reporting that the NBIFOM is supported/enabled. In addition, the P-GW 530 allows the create session response message to contain the configuration of the presence reporting area, that is, a presence reporting area action field (see 3GPP TS 29.274 8.108 Presence Reporting Area Action).

TABLE 3

| | Bit | | | | | | | |
|---|---|---|---|---|---|---|---|---|
| Octet | 8 | 7 | 6 | 5 | 4 | 3 | 2 | 1 |

| 1 | Type = 177 | |
|---|---|---|
| 2~3 | Length = n | |
| 4 | Spare | Instance |

| | | |
|---|---|---|
| 5 | Spare | Action |

| 6~8 | Presence Reporting Area Identifier | |
|---|---|---|
| 9 | Number of TAI | Number of RAI |

| | | |
|---|---|---|
| 10 | Spare | Number of Macro eNodeB |
| 11 | Spare | Number of Home eNodeB |
| 12 | Spare | Number of ECGI |
| 13 | Spare | Number of SAI |
| 14 | Spare | Number of CGI |

| | |
|---|---|
| 15~k | TAIs [1 . . . 15] |
| (k + 1)~m | Macro eNB IDs [1 . . . 63] |
| (m + 1)~p | Home eNB IDs [1 . . . 63] |
| (p + 1)~q | ECGIs [1 . . . 63] |
| (q + 1)~r | RAIs [1 . . . 15] |
| (r + 1)~s | SAIs [1 . . . 63] |
| (s + 1)~t | CGIs [1 . . . 63] |
| u~(n + 4) | This octet is included only when designated explicitly |

The following table shows the presence reporting area action field.

TABLE 4

| | Value |
|---|---|
| Action | (Decimal) |
| Start reporting of a change of a presence of a UE in PRA | 1 |
| Stop reporting of the change of the presence of the UE in the | 2 |
| PRA | |
| <spare> | 0, 3-7 |

6) Meanwhile, the S-GW 520 transmits a create session response message to the MME 510.

7) The MME 510 extracts information for reporting an NBIFOM decision included in the received create session response message, and thereafter allows the extracted information to be included in a PDN connectivity accept message, and transmits to the eNodeB 200 the PDN connectivity accept message being included in a bearer setup request message. Further, the MME 510 initiates to perform a location report as to the UE 100 on the basis of a presence reporting area-related configuration in the received create session response message.

In addition, the MME 510 may configure a tracking area identifier (TAI) list on the basis of the PRA and may transmit a TAU accept message by applying the TAI list in a TAU procedure to be performed later. Accordingly, the MME 510 allows the TAU to be performed by the UE 100 when entering to or exiting from the PRA, so that the MME 510 can effectively acquire location information of the UE 100, which is required by the PCRF 550, and can transmit it to the PCRF 550.

8) The eNodeB 200 extracts the PDN connectivity accept message included in a bearer setup request, and transmits to the UE 100 the extracted PDN connectivity accept message being included in an RRC connection reconfiguration message.

9) The UE 100 extracts the PDN connectivity accept message in the RRC connection reconfiguration message, and extracts information for reporting an NBIFOM decision from the extracted PDN connectivity accept message. Thereafter, the UE 100 transmits an RRC connection reconfiguration complete message to the eNodeB 200.

10) The eNodeB 200 transmits a bearer setup response message to the MME 510.

11˜12) When the UE 100 transmits a direct transfer message to the eNodeB 200, the eNodeB 200 transmits a PDN connectivity complete message to the MME 510.

13) Upon receiving both of the bearer setup response message and the PDN connectivity complete message, the MME 510 transmits a modify bearer request message to the S-GW 520. In this case, information regarding whether the UE 100 is inside or outside the presence reporting area, that is, presence reporting area information, is included in the modify bearer request message. The following table shows the presence reporting area information.

TABLE 5

| | Bit | | | | | | | |
|---|---|---|---|---|---|---|---|---|
| Octet | 8 | 7 | 6 | 5 | 4 | 3 | 2 | 1 |

| 1 | Type = 178 | |
|---|---|---|
| 2~3 | Length = n | |
| 4 | Spare | Instance |

| 5~7 | Presence Reporting Area Identifier | | |
|---|---|---|---|
| 8 | Spare | OPRA | IPRA |

| | |
|---|---|
| 9 to (n + 4) | This octet is included only when designated explicitly |

13) The S-GW 520 transmits the modify bearer request message to the P-GW 530.

13a) Upon receiving the modify bearer request message, the P-GW 530 transmits to the PCRF 550 the presence reporting area information included in the modify bearer request message.

Then, the PCRF 550 determines whether NBIFOM routing information needs to be transmitted to the UE 100. If the PCRF 550 determines that the NBIFOM routing information needs to be transmitted to the UE 100, the PCRF 550 transmits appropriate NBIFOM routing information to the P-GW 530. The NBIFOM routing information may be delivered in the illustrated procedure, and may be delivered through an additional different procedure.

The decision may be performed on the basis of a variety of information. For example, if it is reported from the MME 510 that the UE 100 is present in the configured presence reporting area and a non-congested WLAN is present in a WLAN area corresponding to the configured presence reporting area, NBIFOM routing information including information instructing to perform routing to the WLAN for a specific IP flow may be transmitted to the UE. In this case, WLAN information (e.g., information such as SSID or the like) to which the UE can (or is allowed to or is recommended to) have access may be additionally included.

13b) The P-GW 530 transmits, to the S-GW 520, NBIFOM routing information acquired from the PCRF 550 and being included in a modify bearer response message.

14) The S-GW 520 delivers the modify bearer response message including the NBIFOM routing information to the S-GW 520. Then, the S-GW 520 delivers the NBIFOM routing information to the UE 100.

Upon receiving the NBIFOM routing information, the UE 100 has access to the WLAN in the presence of an IP flow to be routed to the WLAN, and routes the IP flow to the WLAN. Even if there is no IP flow to be routed to the WLAN, the access to the WLAN may be achieved for a later usage.

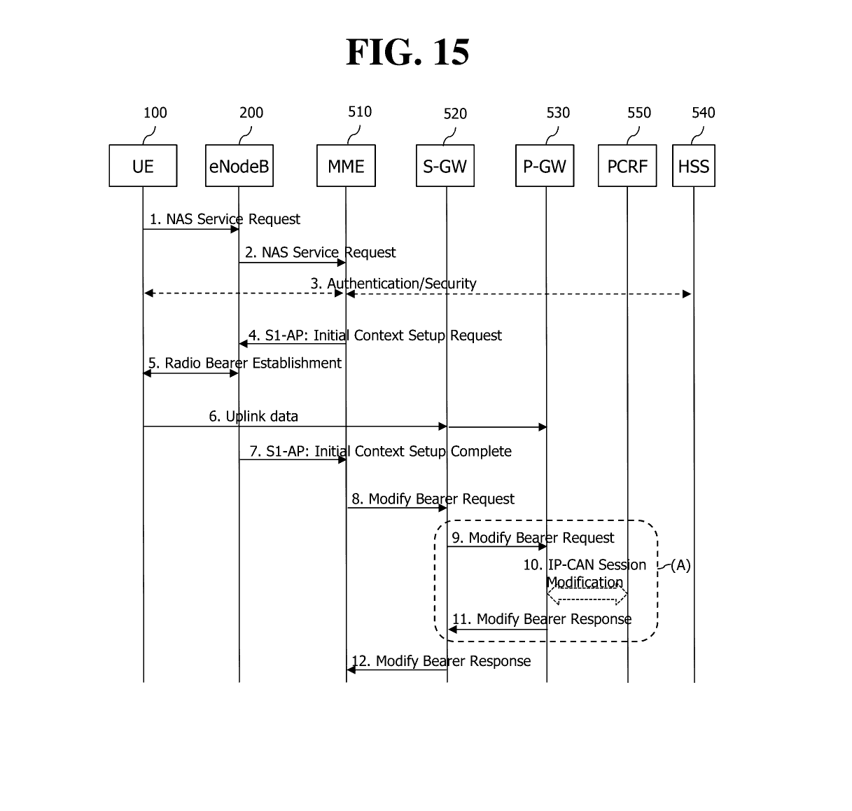

FIG. 15 illustrates a procedure for performing network-initiated NBIFOM on the basis of a UE location and a presence reporting area configured in the MME 510.

It is assumed that, before the procedure illustrated in FIG. 15 is performed, the presence reporting area configuration in the MME 510 is received from the PCRF/P-GW 530 to receive a location report of the UE. For example, the presence reporting area configuration may be received from the PCRF/P-GW 530 through the steps 4 to 6 of FIG. 14. Alternatively, the presence reporting area configuration may be delivered to the MNE 510 through other steps.

1) The UE 100 transmits to the eNodeB 200 a service request message based on a NAS layer.

2) The eNodeB 200 transmits to the MME 510 the service request message being included in an S1 message called INITIAL UE MESSAGE. In this case, the eNodeB 200 transmits the message to the MME 510 by including an ECGI and an ID (i.e., TAI) of a tracking area in which the UE 100 is located. The following table shows the initial UE message, and the clause 9.1.7.1 of 3GPP TS 36.413 is incorporated herein by reference for further details.

TABLE 6

| IE/Group Name | Description |
|---|---|
| Message Type | |
| eNB UE S1AP ID | |
| NAS-PDU | |
| TAI | Indicate a tacking area confirmed from a |
| | NAS message transmitted by the UE |
| E-UTRAN CGI | Indicate E-UTRAN CGI confirmed from |
| | the NAS message transmitted by the UE |
| RRC Establishment Cause | |
| S-TMSI | |
| CSG Id | |
| GUMME(510)I | |
| Cell Access Mode | |
| GW Transport Layer Address | Indicate a transport layer address of a |
| | GW when the GW is in eNodeB |
| Relay Node Indicator | Indicate a relay node |
| GUMME(510)I Type | |
| Tunnel Information for BBF | Indicate a local IP address of a home |
| | eNodeB allocated by a broadband access |
| | operator |
| SIPTO L-GW Transport | Indicate an SIPTO L-GW transport layer |
| Layer Address | address when an SIPTO L-GW is in the |
| | eNodeB |
| LHN ID | |

3) An authentication/security procedure is performed between the UE 100 and the MME 510 and the HSS 540.

4) The MME 510 transmits to the eNodeB 200 an initial context setup request message being included in an S1-AP message.

5) The eNodeB 200 establishes a radio bearer with respect to the UE 100.

6) Then, the UE 100 may transmit uplink data.

7) Meanwhile, the eNodeB 200 transmits the initial context setup complete message being included in the S1-AP message.

8) On the basis of TAI and/or ECGI included in the service request message, the MME 510 confirms that the UE 100 has entered from the outside of the configured presence reporting area. Then, the UE 510 transmits to the S-GW 520 the modify bearer request message including information for reporting that the UE 100 has entered into the configured presence reporting area, that is, presence reporting area information.

9) The S-GW 520 transmits the modify bearer request message to the P-GW 530.

10) The P-GW 530 transmits the presence reporting area information included in the modify bearer request message to the PCRF 550.

The PCRF 550 determines whether there is a need to transmit the NBIFOM routing information to the UE 100 on the basis of the presence reporting area information. If it is determined that the transmission is necessary, the PCRF 550 transmits the NBIFOM routing information to the P-GW 530 in order to transmit it to the UE 100. As such, the operation of transmitting the NBIFOM routing information may be performed as a separate procedure or may be performed in an integrated manner.

The decision may be based on a variety of information described above. For example, if the UE 100 is a special subscriber and there is a non-congested WLAN in a WLAN area corresponding to the configured presence reporting area, the NBIFOM routing information including information instructing to route a specific IP flow of the UE to the WLAN may be delivered to the UE. In this case, WLAN information (e.g., information such as SSID or the like) to which the UE can (or is allowed to or is recommended to) have access may be additionally included.

Upon receiving the NBIFOM routing information, the UE 100 has access to the WLAN in the presence of an IP flow to be routed to the WLAN, and routes the IP flow to the WLAN. Even if there is no IP flow to be routed to the WLAN, the access to the WLAN may be achieved for a later usage.

Although the service request procedure is exemplified in FIG. 14, if all types of NAS messages (e.g., a TAU request message, a bearer resource modify request message, etc.) are received from the UE, the MME 510 may perform the aforementioned operation. Meanwhile, the eNodeB 200 may transmit to the MME 510 a NAS message sent from the UE 100 and being contained in an S1 message called an initial UE message, and may transmit to the MME 510 the NAS message being contained in an S1 message called UPLINK NAS TRANSPORT. The two messages are used differently such that the uplink NAS transport message is used in a case where an S1-connection for the UE pre-exists with respect to the MME 510, and otherwise, the initial UE message is used.

The following table shows the initial NAS transport message, and the clause 9.1.7.3 of 3GPP TS 36.413 is incorporated herein by reference for further details. As can be seen from the following message format, the eNB transmits the initial NAS transport message to the MME 510 by containing an ECGI and an ID (i.e., TAI) of a tracking area in which the UE is located.

TABLE 7

| Name | Description |
|---|---|
| Message Type | |
| MME(510) UE S1AP ID | |
| eNB UE S1AP ID | |
| NAS-PDU | |
| E-UTRAN CGI | |
| TAI | |
| GW Transport Layer Address | Indicate a transport layer address of a |
| | GW when the GW is in eNodeB |
| SIPTO L-GW Transport Layer | Indicate an SIPTO L-GW transport layer |
| Address | address when an SIPTO L-GW is in the |
| | eNodeB |
| LHN ID | |

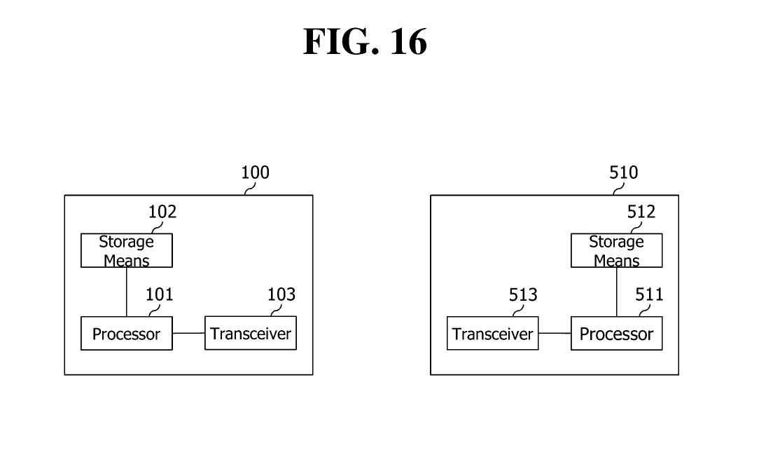

The content described up to now can be implemented in hardware. This will be described with reference to FIG. 16.

FIG. 16 is a block diagram of a UE 100 and an MME 510 according to one disclosure of the present specification.

As shown in FIG. 16, the UE 100 includes a storage unit 102, a controller 101, and a transceiver 103. Further, the MME 510 includes a storage unit 512, a controller 511, and a transceiver 513

The storage units 102 and 512 store the aforementioned method.

The controllers 101 and 511 control the storage units 102 and 512 and the transceivers 103 and 513. More specifically, the controllers 101 and 511 respectively execute the methods stored in the storage units 102 and 512. Further, the controllers 101 and 511 transmit the aforementioned signals via the transceivers 103 and 513.

Although exemplary embodiments of the present invention have been described above, the scope of the present invention is not limited to the specific embodiments and the present invention may be modified, changed, or improved in various ways within the scope of the present invention and the category of the claims.

What is claimed is:

1. A method of delivering a routing rule, the method performed by a network entity in charge of a control plane and comprising:
receiving a network-initiated network-based IP flow mobility (NBIFOM) request from a user equipment (UE);
receiving a configuration of a presence reporting area from a server;
determining whether the UE has entered a specific location on the basis of the configuration of the presence reporting area;
delivering information on the presence reporting area if the UE has entered the specific location;
receiving a routing rule from the server; and
delivering the routing rule to the UE.

2. The method of claim 1, wherein the specific location is checked through a cell identifier (ID) included in an S1-AP message in which a message of a non access stratum (NAS) layer from the UE is encapsulated.

3. The method of claim 2, wherein the message of the NAS layer corresponds to any one of a tracking area update (TAU) request message and a service request message.

4. The method of claim 1, wherein the network-initiated NBIFOM request from the UE is received by being included in a packet data network (PDN) connectivity request message or an attach request message.

5. The method of claim 1, wherein the configuration of the presence reporting area is received by being included in a create session response message.

6. The method of claim 5, wherein the receiving of the configuration of the presence reporting area comprises:
receiving by a packet data network gateway (PDN-GW) the configuration of the present reporting area from the server;
receiving by a serving gateway (S-GW) the configuration of the presence reporting area from the PDN-GW; and
receiving by the network entity the configuration of the presence reporting area from the S-GW.

7. The method of claim 1, wherein the network entity is a mobility management entity (MME), and the server is a policy and charging rule function (PCRF).

8. A network entity in charge of a control plane, comprising:
a transceiver for receiving a network-initiated network-based IP flow mobility (NBIFOM) request from a user equipment (UE), and for receiving a configuration of a presence reporting area from a server; and
a controller for determining whether the UE has entered a specific location on the basis of the configuration of the presence reporting area,
wherein if the UE has entered the specific location, the controller delivers information on the presence reporting area via the transceiver, and thereafter upon receiving a routing rule from the server, delivers the routing rule to the UE.

9. The network entity of claim 8, wherein the specific location is checked through a cell identifier (ID) included in an S1-AP message in which a message of a non access stratum (NAS) layer from the UE is encapsulated.

10. The network entity of claim 9, wherein the message of the NAS layer corresponds to any one of a tracking area update (TAU) request message and a service request message.

11. The network entity of claim 8, wherein the network-initiated NBIFOM request from the UE is received by being included in a packet data network (PDN) connectivity request message or an attach request message.

12. The network entity of claim 8, wherein the configuration of the presence reporting area is received by being included in a create session response message.
